(19) United States
(12) Patent Application Publication
(10) Pub. No.: US 2023/0186059 A1
(43) Pub. Date: Jun. 15, 2023

(54) NEURAL NETWORKS BASED ON HYBRIDIZED SYNAPTIC CONNECTIVITY GRAPHS

(71) Applicant: X Development LLC, Mountain View, CA (US)

(72) Inventors: Sarah Ann Laszlo, Mountain View, CA (US); Estefany Kelly Buchanan, New York, NY (US); Baihan Lin, New York, NY (US)

(21) Appl. No.: 17/547,107

(22) Filed: Dec. 9, 2021

(51) Int. Cl. G06N 3/06; G06N 3/04

(52) U.S. Cl. CPC G06N 3/061; G06N 3/0472

(57) ABSTRACT

In one aspect, there is provided a method performed by one or more data processing apparatus that includes obtaining a network input and processing the network input using a neural network to generate a network output that defines a prediction for the network input. The method further includes processing the network input using an encoding sub-network of the neural network to generate an embedding of the network input, processing the embedding of the network input using a brain hybridization sub-network of the neural network to generate an alternative embedding of the network input, and processing the alternative embedding of the network input using a decoding sub-network of the neural network to generate the network output that defines the prediction for the network input.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a method implemented as computer programs on one or more computers in one or more locations for processing a neural network input using a neural network that includes a brain hybridization sub-network, having an architecture that is specified by a brain hybridization graph, to generate a network output that defines a prediction for the network input. The brain hybridization graph can be a combination of: (i) a first sub-graph of a first synaptic connectivity graph representing synaptic connectivity between biological neuronal elements in a first biological organism brain, and (ii) a second sub-graph of a second synaptic connectivity graph representing synaptic connectivity between biological neuronal elements in a second biological organism brain.

Throughout this specification, a “synaptic connectivity graph” can refer to a graph that represents a biological connectivity between neuronal elements in a brain of a biological organism. A “neuronal element” can refer to an individual neuron, a portion of a neuron, a group of neurons, or any other appropriate biological neuronal element, in the brain of the biological organism. The synaptic connectivity graph can include multiple nodes and edges, where each edge connects a respective pair of nodes. A “sub-graph” of the synaptic connectivity graph can refer to a graph specified by: (i) a proper subset of the nodes of the synaptic connectivity graph, and (ii) a proper subset of the edges of the synaptic connectivity graph.

A “brain hybridization graph” can refer to a graph that is a combination of multiple sub-graphs, e.g., the first sub-graph of the first synaptic connectivity graph and the second sub-graph of the second synaptic connectivity graph. In other words, the brain hybridization graph can represent different regions of the brain of multiple respective biological organisms. The organisms can be the same biological organism (e.g., a fly), or different biological organisms (e.g., a fly, a cat, a fish, a mouse, or a human). Generally, the brain hybridization graph can represent any number of regions of the brain of any number and type of biological organisms.

For convenience, throughout this specification, a neural network having an architecture specified by a brain hybridization graph can be referred to as a “brain hybridization” neural network. Identifying an artificial neural network as a “brain hybridization” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

According to a first aspect, there is provided a method performed by one or more data processing apparatus, the method including: obtaining a network input, and processing the network input using a neural network to generate a network output that defines a prediction for the network input, including: processing the network input using an encoding sub-network of the neural network to generate an embedding of the network input, processing the embedding of the network input using a brain hybridization sub-network of the neural network to generate an alternative embedding of the network input, where: the brain hybridization sub-network has a neural network architecture that is specified by a brain hybridization graph, and the brain hybridization graph is a combination of: (i) a first sub-graph of a first synaptic connectivity graph representing synaptic connectivity between a plurality of biological neuronal elements in a first biological organism brain, and (ii) a second sub-graph of a second synaptic connectivity graph representing synaptic connectivity between a plurality of biological neuronal elements in a second biological organism brain, and processing the alternative embedding of the network input using a decoding sub-network of the neural network to generate the network output that defines the prediction for the network input.

In some implementations, the first biological organism brain is of a first biological organism and the second biological organism brain is of a second biological organism, and the first biological organism and the second biological organism are different biological organisms.

In some implementations, each biological neuronal element is a biological neuron, a part of a biological neuron, or a group of biological neurons.

In some implementations, the first sub-graph of the first synaptic connectivity graph is selected based on a set of features that characterize a biological function of the corresponding biological neuronal elements in the first biological organism brain, and the second sub-graph of the second synaptic connectivity graph is selected based on a set of features that characterize a biological function of the corresponding biological neuronal elements in the second biological organism brain.

In some implementations, the biological function of the corresponding biological neuronal elements in the first biological organism brain, and the biological function of the corresponding biological neuronal elements in the second biological organism brain, are different biological functions.

In some implementations, the first sub-graph is represented as a first two-dimensional weight matrix of brain emulation parameters.

In some implementations, the first weight matrix has a plurality of rows and a plurality of columns, where each row and each column of the first weight matrix corresponds to a respective biological neuronal element in the first biological organism brain, and where each brain emulation parameter in the first weigh matrix corresponds to a respective pair of biological neuronal elements in the first biological organism brain including: (i) the biological neuronal element corresponding to a row of the brain emulation parameter in the first weight matrix, and (ii) the biological neuronal element corresponding to a column of the brain emulation parameter in the first weight matrix.

In some implementations, the second sub-graph is represented as a second two-dimensional weight matrix of brain emulation parameters.

In some implementations, the second weight matrix has a plurality of rows and a plurality of columns, where each row and each column of the second weight matrix corresponds to a respective biological neuronal element in the second biological organism brain, and where each brain emulation parameter in the second weigh matrix corresponds to a respective pair of biological neuronal elements in the second biological organism brain including: (i) the biological neuronal element corresponding to a row of the brain emulation parameter in the second weight matrix, and (ii) the biological neuronal element corresponding to a column of the brain emulation parameter in the second weight matrix.

In some implementations, the brain hybridization graph is defined by a two-dimensional weight matrix, where the weight matrix of the brain hybridization graph is generated by combining the first weight matrix representing the first sub-graph and the second weight matrix representing the second sub-graph.

In some implementations, generating the weight matrix of the brain hybridization graph comprises: concatenating the first weight matrix representing the first sub-graph and the second weight matrix representing the second sub-graph.

In some implementations, generating the weight matrix of the brain hybridization graph comprises: determining the weight matrix of the brain hybridization graph as a linear combination of the first weight matrix representing the first sub-graph and the second weight matrix representing the second sub-graph.

In some implementations, determining the linear combination of the first weight matrix representing the first sub-graph and the second weight matrix representing the second sub-graph comprises: determining a mixing factor; and linearly combining the first weight matrix representing the first sub-graph and the second weight matrix representing the second sub-graph in accordance with the mixing factor.

In some implementations, determining the mixing factor comprises: processing the network input, or an intermediate output of the encoding sub-network, using one or more neural network layers to generate the mixing factor.

In some implementations, the mixing factor is a hyperparameter of the brain hybridization sub-network.

In some implementations, the brain hybridization graph is determined by operations including: initializing the brain hybridization graph as the first sub-graph of the first synaptic connectivity graph representing synaptic connectivity between the plurality of biological neuronal elements in the first biological organism brain; updating the brain hybridization graph at each of a plurality of iterations, including, at each iteration: generating a plurality of candidate brain hybridization graphs based on the brain hybridization graph; determining, for each candidate brain hybridization graph, a respective similarity measure between the candidate brain hybridization graph and the second sub-graph representing synaptic connectivity between biological neuronal elements in the second biological organism brain; and updating the brain hybridization graph based on the similarity measures determined for candidate brain hybridization graphs; and determining the brain hybridization graph based on the similarity measures determined for the candidate brain hybridization graphs over the plurality of iterations.

In some implementations, generating the plurality of candidate brain hybridization graphs based on the brain hybridization graph, comprises, for each candidate brain hybridization graph: determining the candidate brain hybridization graph by applying a graph modification operator to the brain hybridization graph to add one or more nodes, one or more edges, or both, to the brain hybridization graph.

In some implementations, determining, for each candidate brain hybridization graph, the respective similarity measure between the candidate brain hybridization graph and the second sub-graph representing synaptic connectivity between the plurality of biological neuronal elements in the second biological organism brain comprises, for each candidate brain hybridization graph: determining a first set of graph statistics characterizing the candidate brain hybridization graph; determining a second set of graph statistics characterizing the second sub-graph; and determining the similarity measure between the candidate brain hybridization graph and the second sub-graph based on a similarity between the first set of graph statistics and the second set of graph statistics.

According to a second aspect, there is provided a system that includes one or more computers, and one or more storage devices communicatively coupled to the one or more computers, where the one or more storage devices store instructions that, when executed by the one or more computers, cause the one or more computers to perform operations of any preceding aspect.

According to a third aspect, there are provided one or more non-transitory computer storage media storing instructions that when executed by one or more computers cause the one or more computers to perform operations of any preceding aspect.

Particular embodiments of the subject matter described in this specification can be implemented so as to realize one or more of the following advantages.

The method described in this specification can generate a brain hybridization neural network architecture based on a brain hybridization graph that represents different brain regions of multiple respective biological organisms. Generally, the brains of biological organisms may be adapted by evolutionary pressures to be effective at solving certain tasks, e.g., classifying objects or generating robust object representations. Each biological organism can be uniquely adapted for solving certain tasks. For example, some biological organisms can be more effective at processing visual data under specific sets of conditions than other biological organisms. The method described in this specification can generate the brain hybridization neural network architecture that can harness these unique capabilities of each biological organism at performing a particular task in a single neural network architecture.

Other techniques can generate a biologically-inspired neural network architecture that is based on a single region of the brain of a single biological organism. However, the effectiveness of such biologically-inspired neural networks can be limited to the specific task that the biological organism is adapted to perform. By contrast, the method described in this specification can intelligently identify the “best” cognitive abilities of different biological organisms and capture them in a single brain hybridization neural network architecture that can perform a variety of different machine learning tasks. Furthermore, the brain hybridization neural network can automatically learn to prioritize each particular cognitive ability according to, e.g., a particular machine learning task that it is required to perform. This can significantly reduce consumption of computational resources (e.g., memory and computing power) by the brain hybridization neural network, e.g., enabling the brain hybridization neural network to be deployed in resource-constrained environments, e.g., mobile devices, when compared to other (e.g., hand-engineered) neural network architectures.

Further, the brain hybridization neural network can not only capture the evolutionarily-shaped cognitive abilities of a particular biological organism, but also bypass the limitations of slow evolutionary processes by artificially combining cognitive abilities of different biological organisms to create a single multi-capable and intelligent system. Therefore, a neural network that includes a brain hybridization sub-network (e.g., a sub-network having an architecture that is specified by the brain hybridization graph) can require less training data, fewer training iterations, and/or less computational resources, to effectively solve certain tasks, when compared to other biologically-inspired neural network architectures, e.g., architectures based on a single biological organism brain.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example data flow for generating a brain hybridization neural network architecture based on a brain hybridization graph.

FIG. 2 is a block diagram of an example merging system that generates a brain hybridization neural network architecture based on a brain hybridization graph.

FIG. 3 is a block diagram of an example sub-graph selection system that selects sub-graphs for a brain hybridization graph.

FIG. 4 illustrates an example brain hybridization graph.

FIG. 5A illustrates an example weight matrix of a sub-graph of a synaptic connectivity graph.

FIG. 5B illustrates an example of linearly combining a first weight matrix and a second weight matrix to generate a weight matrix representing a brain hybridization graph.

FIG. 5C illustrates an example of concatenating a first weight matrix and a second weight matrix to generate a weight matrix representing a brain hybridization graph.

FIG. 5D illustrates an example of evolutionary hybridization of a first weight matrix and a second weight matrix to generate a weight matrix representing a brain hybridization graph.

FIG. 6 is a block diagram of an example neural network computing system that includes a brain hybridization sub-network based on a brain hybridization graph.

FIG. 7 is a flow diagram of an example process for processing a network input using a neural network that includes a brain hybridization sub-network based on a brain hybridization graph.

FIG. 8 is an example data flow for generating a synaptic connectivity graph based on the brain of a biological organism.

FIG. 9 is a flow diagram of an example process for generating a brain hybridization neural network architecture based on a brain hybridization graph.

FIG. 10 is a block diagram of an example computer system.

Like reference numbers and designations in the various drawings indicate like elements.

### DETAILED DESCRIPTION

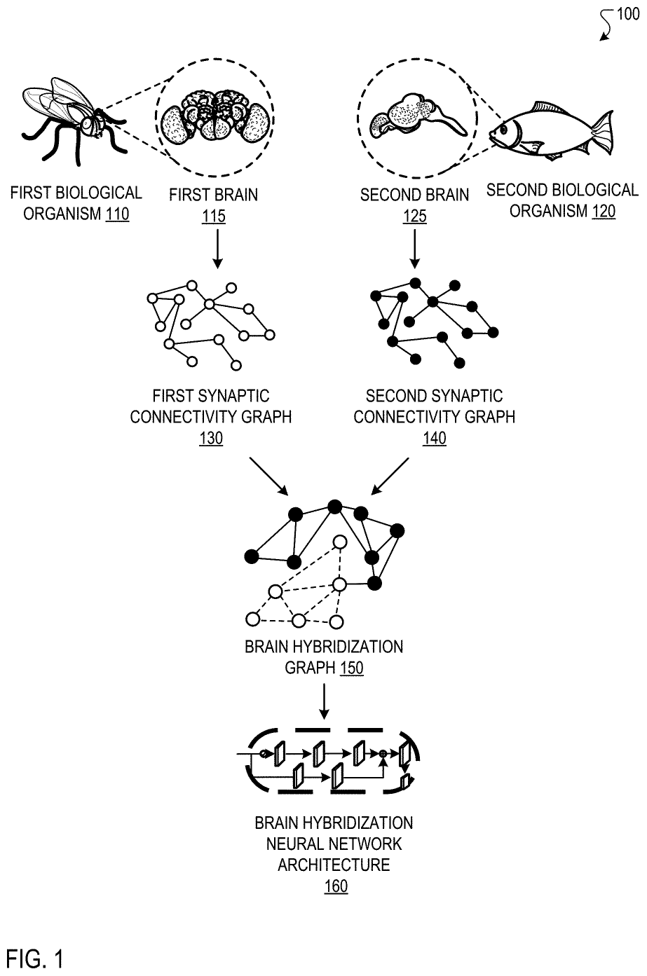

FIG. 1 is an example data flow 100 for generating a brain hybridization neural network architecture 160 based on brains of one or more biological organisms. Generally, the data flow 100 can be used to generate the brain hybridization neuronal network architecture 160 based on the brain of a single biological organism, e.g., the first brain 115 of the first biological organism 110, or multiple biological organisms, e.g., the first brain 115 of the first biological organism 110 and a second brain 125 of a second biological organism 120. The first organism 110 and the second organism 120 can be the same, or different, biological organisms. As used throughout this document, the brain 115, 125 can refer to any amount of nervous tissue from a nervous system of the respective biological organism 110, 120, and nervous tissue can refer to any tissue that includes neurons (i.e., nerve cells). The first 110 and the second 120 biological organisms can be, e.g., a fly, a fish, a worm, a cat, a mouse, or a human.

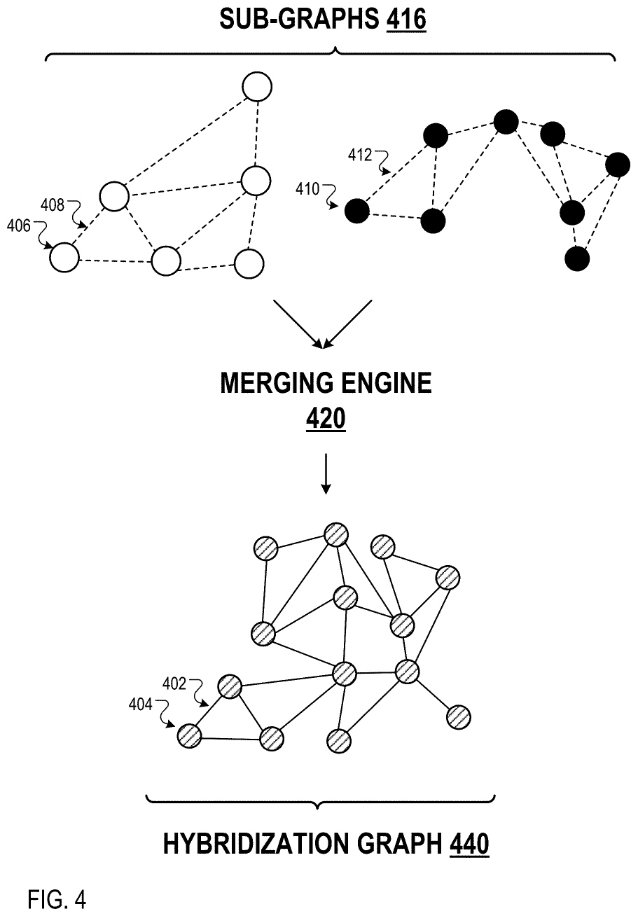

The first synaptic connectivity graph 130 can represent synaptic connectivity between biological neuronal elements in the first biological organism brain 115. Similarly, the second synaptic connectivity graph 140 can represent synaptic connectivity between biological neuronal elements in the second biological organism brain 125. A “neuronal element” can refer to an individual neuron, a portion of a neuron, a group of neurons, or any other appropriate biological element in the brain 115, 125. As will be described in more detail below with reference to FIG. 4, the synaptic connectivity graph 130, 140 can include multiple nodes and multiple edges, where each edge connects a respective pair of nodes. In one example, each node in the graph 130, 140 can represent an individual neuron, and each edge connecting a pair of nodes in the graph 130, 140 can represent a respective synaptic connection between the corresponding pair of individual neurons.

In some implementations, the synaptic connectivity graph 130, 140 can be an “over-segmented” synaptic connectivity graph, e.g., where at least some nodes in the graph represent a portion of a neuron, and at least some edges in the graph connect pairs of nodes that represent respective portions of neurons. In some implementations, the synaptic connectivity graph 130, 140 can be a “contracted” synaptic connectivity graph, e.g., where at least some nodes in the graph represent a group of neurons, and at least some edges in the graph represent respective connections (e.g., nerve fibers) between such groups of neurons. In some implementations, the synaptic connectivity graph 130, 140 can include features of both the “over-segmented” graph and the “contracted” graph. Generally, the synaptic connectivity graph 130, 140 can include nodes and edges that represent any appropriate neuronal element, and any appropriate connection between a pair of neuronal elements, respectively, in the respective biological organism brain 115, 125.

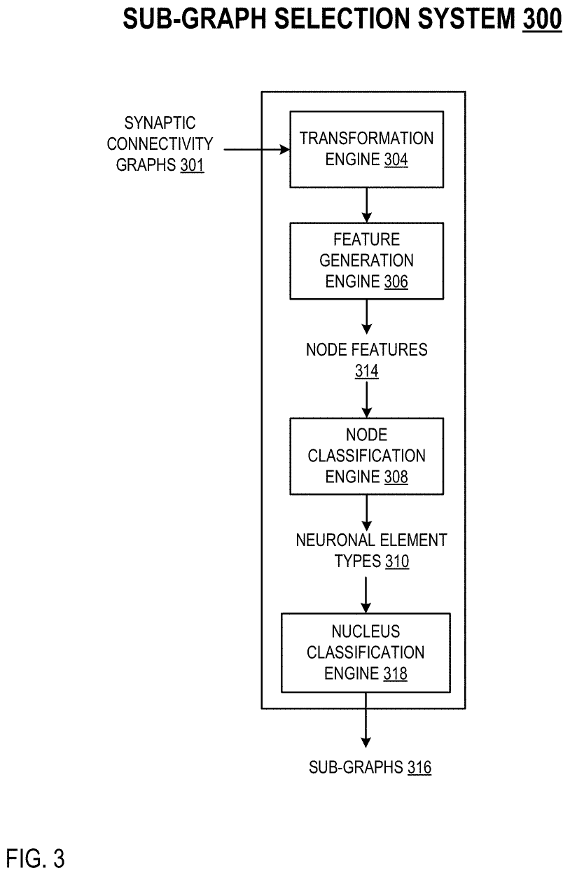

A sub-graph selection system can process the first synaptic connectivity graph 130 and the second synaptic connectivity graph 140 to select one or more sub-graphs of each of the graphs 130, 140. A “sub-graph” of a synaptic connectivity graph 130, 140 can generally refer to a graph specified by: (i) a proper subset of the nodes of the synaptic connectivity graph 130, 140, and (ii) a proper subset of the edges of the synaptic connectivity graph 130, 140. This process will be described in more detail below with reference to FIG. 3.

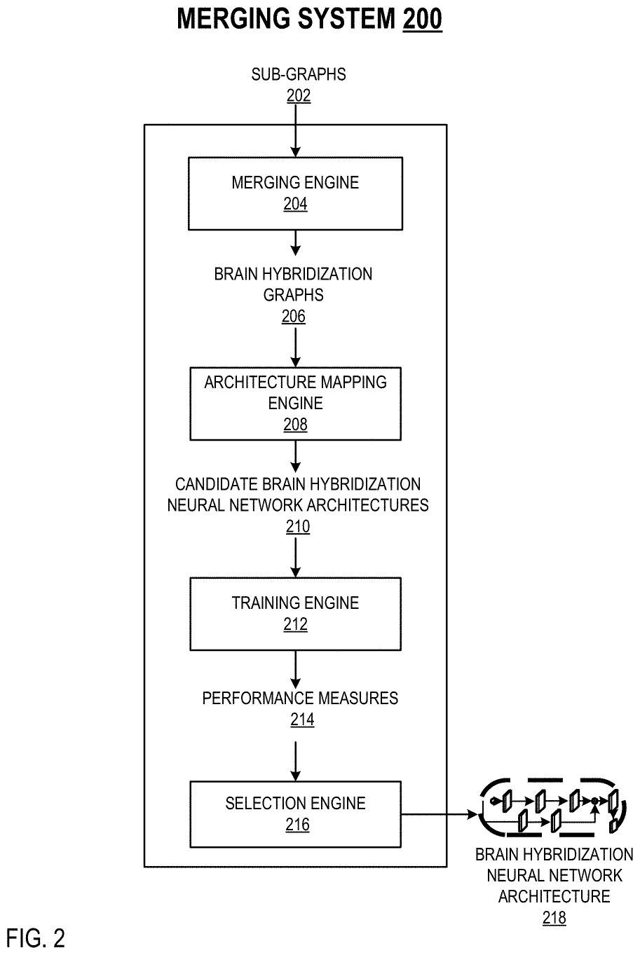

As will be described in more detail below with reference to FIG. 2, a merging system can process the sub-graphs to generate a brain hybridization graph 150. Throughout this specification, a “brain hybridization graph” can refer to a graph that is a combination of two or more sub-graphs of respective synaptic connectivity graphs. In some implementations, the brain hybridization graph 150 can include a sub-graph of the first synaptic connectivity graph 130, representing synaptic connectivity in the first biological organism brain 115, and a sub-graph of the second synaptic connectivity graph 140, representing synaptic connectivity in the second biological organism brain 125. In such cases, the brain hybridization graph 150 can represent regions of the brain of different biological organisms.

In some implementations, the first biological organism bran 115 and the second biological organism brain 125 can be of the same biological organism (e.g., a fly). In such cases, the brain hybridization graph 150 can include, e.g., a sub-graph of the first synaptic connectivity graph 130, and a second, different, sub-graph of the first synaptic connectivity graph 130. In other words, the brain hybridization graph 150 can represent different regions of the brain of the same biological organism. For example, the brain hybridization graph 150 can include a sub-graph that represents a visual processing region of the brain 115 of the first biological organism 110, and a sub-graph that represents an audio processing region of the brain 115 of the first biological organism 110.

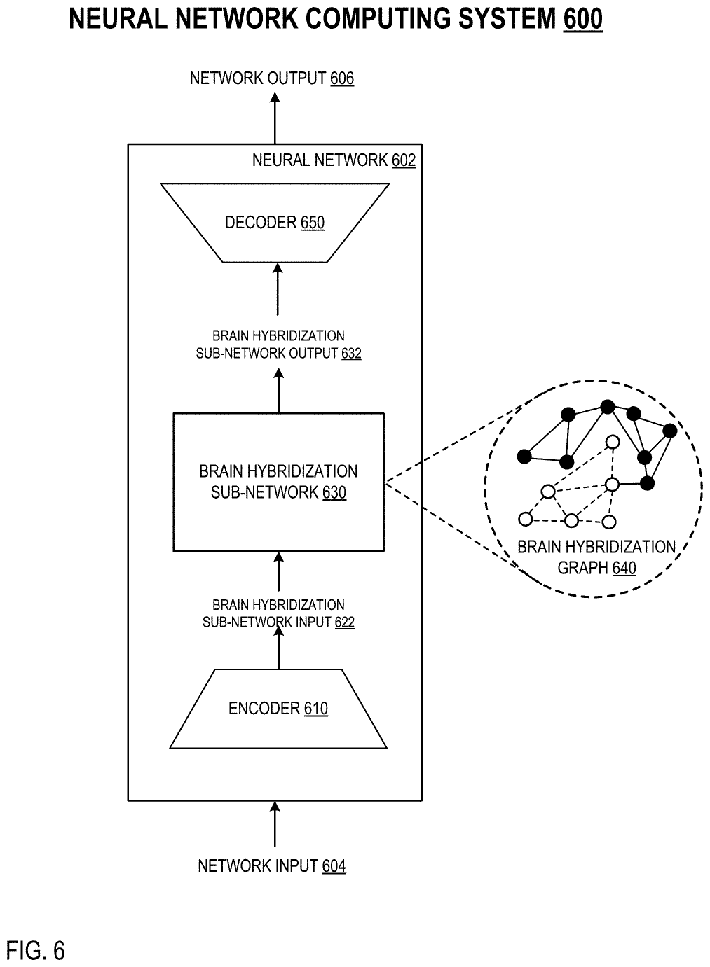

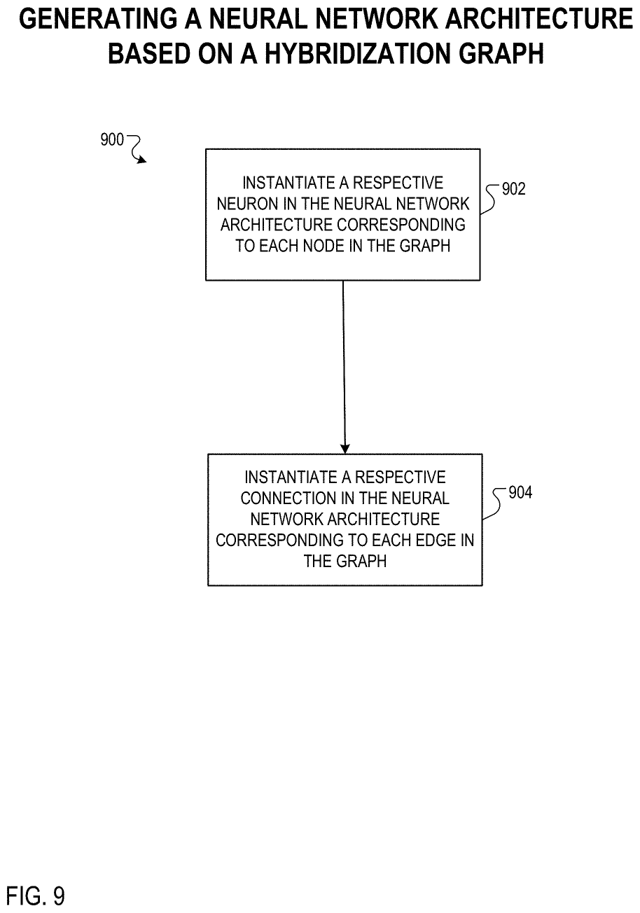

After generating the brain hybridization graph 150, the merging system can process the graph 150 to generate the brain hybridization neural network architecture 160. This process will be described in more detail below with reference to FIG. 9. The architecture 160 can be implemented as part of a neural network, e.g., as a brain hybridization sub-network, and used to perform a machine learning task. This process will be described in more detail below with reference to FIG. 6.

Because the first biological organism brain 115, and the second biological organism brain 125, can be adapted by evolutionary pressures to be effective at performing certain tasks, the brain hybridization neural network architecture 160 can inherit this capacity to effectively solve tasks. In particular, because the brain of each biological organism 110, 120 can be uniquely capable at performing a particular task, the brain hybridization neural network architecture 160 can effectively harness these unique capabilities of multiple different biological organisms in a single neural network architecture.

Furthermore, as will be described in more detail below with reference to FIG. 2, the unique capabilities of different biological organisms can be prioritized in the architecture 160 according to a particular machine learning task that the brain hybridization neural network will be required to perform. For example, in some cases, the visual processing region of the first biological organism brain 115, included in the architecture 160, can have more weight on the overall processing capacity of the architecture 160, when compared to the visual processing region of the second biological organism brain 125 included in the architecture 160.

Accordingly, the brain hybridization neural network, having the brain hybridization neural network architecture 160, can not only outperform conventional (e.g., hand-engineered) neural networks at performing the task, but also other biologically-inspired neural networks, because it can intelligently harness and prioritize natural capabilities of multiple different biological organisms in a single neural network architecture, and jointly fine-tune these capabilities according to a particular machine learning task.

The merging system will be described in more detail below with reference to FIG. 2.

FIG. 2 is a block diagram of an example merging system 200 that can generate a brain hybridization neural network architecture 218 (e.g., the architecture 160 in FIG. 1). The system 200 is an example of a system implemented as computer programs on one or more computers in one or more locations in which the systems, components, and techniques described below are implemented.

As described above with reference to FIG. 1, a synaptic connectivity graph can represent synaptic connectivity between biological neuronal elements in the brain of a biological organism. As will be described in more detail below with reference to FIG. 3, a sub-graph selection system can process the synaptic connectivity graph and generate one or more sub-graphs of the synaptic connectivity graph. For example, the system can select multiple sub-graphs of a single synaptic connectivity graph. As another example, the system can process multiple synaptic connectivity graphs, each representing a respective biological organism brain, and select a sub-graph from each of the graphs.

In some implementations, the system can select one or more sub-graphs based on a set of features that predict a biological function of biological neuronal elements in the corresponding biological organism brain (e.g., a visual function by processing visual data, an olfactory function by processing odor data, or a memory function by retaining information). For example, if the brain hybridization neural network architecture 218 will be required to perform a machine learning task that relates to, e.g., visual processing, the system can select a sub-graph from each of the synaptic connectivity graphs, where each sub-graph represents the visual processing region of the respective biological organism brain. The sub-graph selection system will be described in more detail below with reference to FIG. 3.

The merging system 200 can process the sub-graphs 202 to generate the brain hybridization neural network architecture 218. After generating the architecture 218, the merging system 200 can instantiate a corresponding neural network (e.g., as described below with reference to FIG. 6) and use it to perform the machine learning task.

The merging system 200 can include: (i) a merging engine 204, (ii) an architecture mapping engine 208, (iii) a training engine 212, and (iv) a selection engine, each of which will be described in more detail next.

The merging engine 204 can process data defining the sub-graphs 202 and determine a set of brain hybridization graphs 206. Each brain hybridization graph 206 can be a combination of: (i) a first sub-graph of a first synaptic connectivity graph representing synaptic connectivity between biological neuronal elements in a first biological organism brain, and (ii) a second sub-graph of a second synaptic connectivity graph representing synaptic connectivity between biological neuronal elements in a second biological organism brain. The first biological organism brain and the second biological organism brain can be of the same biological organism, or different biological organisms. Generally, the merging engine 204 can combine any number of sub-graphs 202 (or synaptic connectivity graphs) to generate the brain hybridization graph 206, e.g., 10 sub-graphs, 100 sub-graphs, 1000 sub-graphs, or any other appropriate number of sub-graphs (or synaptic connectivity graphs). The merging engine 204 can generate the brain hybridization graphs 206 using any variety of techniques. A few examples follow.

In some implementations, the merging engine 204 can combine the first sub-graph and the second sub-graph based on a matrix representation of each of the sub-graphs. For example, the merging engine 204 can combine the matrix representations of sub-graphs to generate a new matrix. In some implementations, this new matrix itself can represent a graph, e.g., the brain hybridization graph. For example, each row in the new matrix can represent, e.g., an input node, and each column in the new matrix can represent, e.g., an output node. The parameters included in the new matrix can represent, e.g., the connectivity between the input nodes and the output nodes.

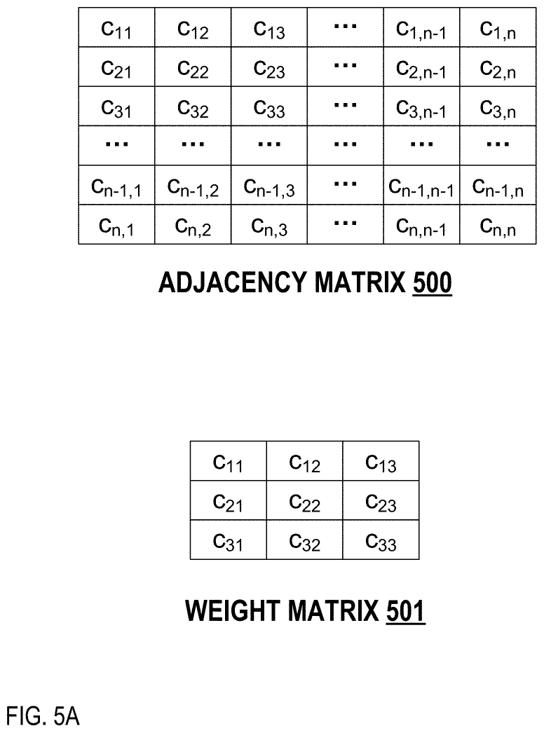

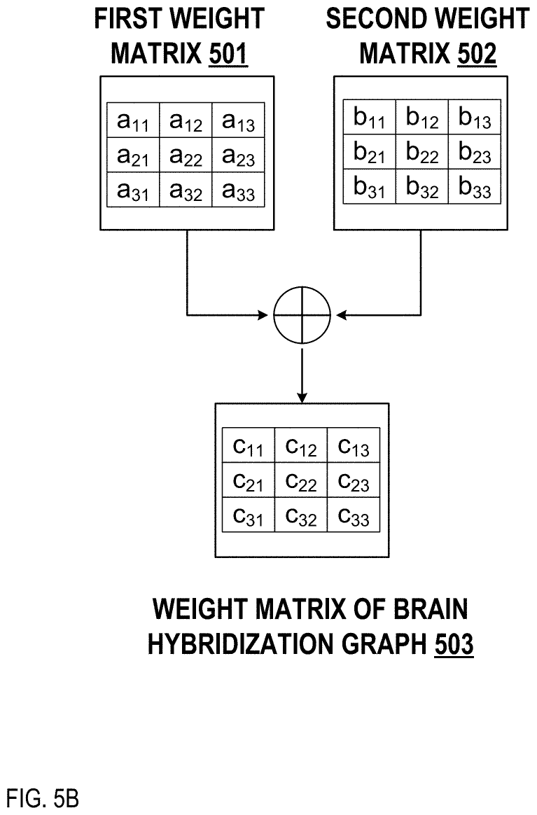

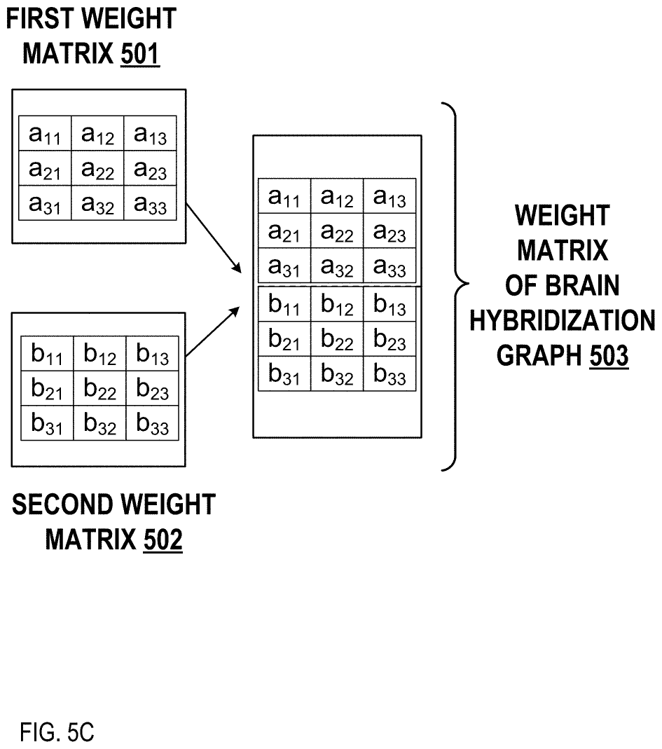

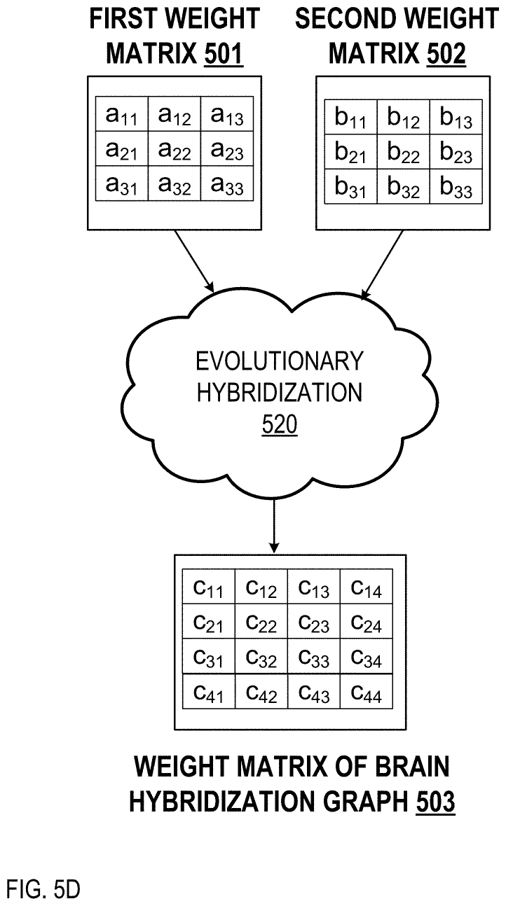

As will be described in more detail below with reference to FIG. 5A, the synaptic connectivity graph can generally be represented by a two-dimensional array of numerical values (e.g., an adjacency matrix) with a number of rows and columns equal to the number of nodes in the synaptic connectivity graph. A sub-graph of the synaptic connectivity graph can be represented using a portion of the adjacency matrix, e.g., a weight matrix. In one example, the weight matrix can be an M×N matrix, where each of the M rows corresponds to a neuronal element in a first set of neuronal elements and each of the N columns corresponds to a neuronal element in a second set of neuronal elements in the brain of the biological organism.

Each of the sub-graphs 202 can be represented by its own weight matrix. For example, each row and each column of a first weight matrix, representing the first sub-graph, can correspond to a respective biological neuronal element in the first biological organism brain. Similarly, each row and each column of a second weight matrix, representing the second sub-graph, can correspond to a respective biological neuronal element in the second biological organism brain. The merging engine 204 can combine the first weight matrix and the second weight matrix to generate a combined matrix, e.g., a weight matrix representing the brain hybridization graph 206. In other words, the weight matrix of the bran hybridization graph 206 can represent a combination of a region of the first biological organism brain, and a region of the second biological organism brain. Examples of weight matrices of brain hybridization graphs are described in more detail below with reference to FIG. 5.

In one example, to generate the weight matrix of the brain hybridization graph 206, the merging engine 202 can combine the first sub-graph and the second sub-graph by concatenating the first weight matrix and the second weight matrix, respectively. The merging engine 202 can concatenate the weight matrices horizontally, or vertically. Generally, two matrices can be horizontally concatenated when they include the same number of rows m, and vertically concatenated when they include the same number of columns n. The merging engine 202 can modify the weight matrices in any appropriate manner such that they can be horizontally, or vertically, concatenated. For example, the merging engine 202 can remove one or more rows, and/or one or more columns, from each of the weight matrices.

As a particular example, if the first weight matrix A, representing the first sub-graph, has dimensions (m₁, n₁), and the second weight matrix B representing the second sub-graph, has dimensions (m₂, n₂), the merging engine 202 can horizontally concatenate the weight matrices A and B as follows C=└A, B┘, a where C is the weight matrix of the brain hybridization graph 206. In this case, the weight matrix C can have dimensions (m₁=m₂, n₁+n₂). In another particular example, the merging engine can vertically concatenate the first weight matrix A and the second weight matrix B as follows C=[_{B}^{A}], where C is the weight matrix of the brain hybridization graph 206. In this case, the weight matrix C can have dimensions (m₁+m₂, n₁=n₂).

As another example, the merging engine 202 can linearly combine the first weight matrix and the second weight matrix, to generate the weight matrix of the brain hybridization graph 206. Generally, two matrices can be linearly combined when they have the same number of rows m and the same number of columns n. The merging engine 202 can modify the weight matrices in any appropriate manner such that they can be linearly combined. For example, the merging engine 202 can remove one or more rows, and/or one or more columns, from each of the weight matrices.

As a particular example, the merging engine 202 can linearly combine the first weight matrix A and the second weight matrix B as follows C=αA+(1−α)B, where C is the weight matrix of the brain hybridization graph 206. In this case, the weight matrix C can have dimensions (m₁=m₂, n₁=n₂). In some implementations, the merging engine 202 can determine a respective mixing factor α for each of the first weight matrix, representing the first sub-graph, and the second weight matrix, representing the second sub-graph. Generally, a “mixing factor” can refer to any appropriate parameter that can prioritize one weight matrix over another weight matrix. In one example, the mixing factor can be a numerical value that, when multiplied with a weight matrix, can modify the elements of the weight matrix by an amount equal to the numerical value. As another particular example, the merging engine 202 can linearly combine more than two weight matrices (e.g., 5, 10, 100, 1000, etc. weight matrices), where each weight matrix is multiplied by a normalized mixing factor, e.g., the values of the respective importance factors of all weight matrices that are being linearly combined can sum to one. The mixing factor will be described in more detail below with reference to FIG. 6.

In some implementations, instead of directly combining the first sub-graph and the second sub-graph based on their respective weight matrix representations, the merging engine 202 can combine the first sub-graph and the second sub-graph based on a set of graph statistics characterizing each of the sub-graphs. For example, the merging engine 202 can initialize a brain hybridization graph as the first sub-graph, and iteratively update (or evolve) the brain hybridization graph. At each iteration, the merging engine 202 can compute a similarity measure between the brain hybridization graph and the second sub-graph based on their respective sets of graph statistics. In this way, the merging engine 202 can gradually evolve the brain hybridization graph under the constraints of similarity to the second sub-graph, and thereby generate the brain hybridization graph 206 that is an approximate combination of the first sub-graph and the second sub-graph. This process will be described in more detail below.

The merging engine 202 can initialize the brain hybridization graph as the first sub-graph of the first synaptic connectivity graph, representing synaptic connectivity between biological neuronal elements in the first biological organism brain. At each iteration, the merging engine 202 can update the brain hybridization graph by generating multiple candidate brain hybridization graphs. To generate the candidate graphs, the merging engine 202 can apply a graph modification operator to the brain hybridization graph to expand it by, e.g., adding one or more nodes, one or more edges, or both, to the brain hybridization graph. The graph modification operator can optionally contract the brain hybridization graph by, e.g., removing one or more nodes, one or more edges, or both, from the brain hybridization graph. Generally, the graph modification operator can modify the brain hybridization graph in any other appropriate manner. Each time the merging engine 202 applies the graph modification operator to the brain hybridization graph, the merging engine 202 can generate a new candidate brain hybridization graph.

As a particular example, the graph modification operator can select a single node (a parent node) in the brain hybridization graph and find all other nodes (child nodes) in the graph to which the single node can be connected to, and calculate a fitness value for each of the possible connections between the parent node and each of the child nodes. The fitness value can be determined by the statistical properties of the brain hybridization graph and/or the second sub-graph. For example, the fitness value can take into account size-normalized graph statistics (e.g., statistical parameters averaged over the total number of nodes or edges in the graph). Example statistical properties of graphs will be described in more detail below.

Calculating the fitness value for each of the possible connections between the parent node and each of the child nodes can allow the graph modification operator to determine which connection would make the brain hybridization graph have a desired degree of similarity to the second sub-graph. On the basis of the fitness value, the graph modification operator can probabilistically add (or remove) a connection between the parent node and one of the child nodes to generate the candidate brain hybridization graph. Similarly, the graph modification operator can calculate a fitness value for adding (or removing) a single node, or an edge and a node, to the brain hybridization graph, and generate the candidate brain hybridization graph on that basis. The selection of a feature in the brain hybridization graph (e.g., a node, an edge, or both) and the addition of a feature to (or the removal of a feature from) the brain hybridization graph (e.g., a node, an edge, or both) can have an associated stochastic component so that the graph modification operator can generate a different candidate brain hybridization graph each time it is applied to the brain hybridization graph.

Instead of selecting a single node in the brain hybridization graph, the graph modification operator can select a subset of the nodes and a subset of the edges of the graph. For example, the graph modification operator can randomly select a node (e.g., a “root” node) in the brain hybridization graph and select every node and edge that is connected to the root node by a path having at most a predefined length (e.g., 3). The graph modification operator can copy the subset of the nodes and the subset of the edges and paste it into the brain hybridization graph, e.g., by adding a new copy of the subsets into the graph, and instantiating connections (randomly or otherwise) between the new nodes and the existing nodes of the brain hybridization graph. As mentioned above, there can be a stochastic component associated with selecting a particular subset of nodes and subset of edges and pasting them into (or removing them from) the brain hybridization graph such that the graph modification operator can generate a different candidate brain hybridization graph every time it is applied to the brain hybridization graph.

After generating multiple candidate brain hybridization graphs, the merging engine 202 can determine, for each candidate graph, a respective similarity measure between the candidate graph and the second sub-graph. In this way, the merging engine 202 can determine how similar each of the candidate graphs is to the second sub-graph. As described above, the similarity measure can be based on a respective set of graph statistics characterizing each of the graphs. The merging engine 202 can determine any appropriate statistical parameters. A few examples follow.

As described above, each of the sub-graphs, and the brain hybridization graph, can be represented by a weight matrix. For each of the graphs, or sub-graphs, the merging engine 202 can determine, e.g., the spectrum of its respective matrix. Generally, a spectrum of a matrix can refer to the set of its eigenvalues and can carry information about the structure of the matrix. In another example, the merging engine 202 can determine size-normalized statistical parameters for each of the graphs, or sub-graphs. The size of a graph can generally be determined by, e.g., the total number of nodes or the total number of edges in the graph. For each graph, the merging engine 202 can determine the total number of edges connected to each node in the graph averaged over the total number of nodes in the graph. In another example, for each graph, or sub-graph, the merging engine 202 can determine the total number of loops in the graph, where a loop can be defined as a connection from each component in a sequence to the next component where the first and last components of the sequence are identical, averaged by the total number of nodes in the graph.

At each iteration, the merging engine 202 can determine a set of graph statistics, as described above, for each of the candidate brain hybridization graphs, and aggregate the set into a respective feature vector that can characterize each of the graphs. Accordingly, at each iteration, the merging engine 202 can determine the similarity measure between each of the candidate brain hybridization graphs and the second sub-graph as a Euclidean distance between the respective feature vector of each of the candidate graphs and the feature vector of the second sub-graph. For example, the candidate brain hybridization graph that most closely resembles the second sub-graph in terms of the statistical parameters can have a higher similarity measure than the other candidate brain hybridization graphs.

Based on the similarity measures determined for each of the candidate brain hybridization graphs with respect to the second sub-graph, at each iteration, the merging engine 202 can update the brain hybridization graph. For example, the merging engine can select the candidate bran hybridization graph that has, e.g., the highest similarity measure with the second sub-graph, as a new brain hybridization graph. After updating the brain hybridization graph, the merging engine 202 can proceed to the next iteration. The merging engine 202 can terminate the process, e.g., after a termination criterion is satisfied. For example, the engine 202 can terminate the process when a desired degree of similarity between any of the candidate brain hybridization graphs and the second sub-graph has been reached. In another example, the engine 202 can terminate the process after a predetermined number of iterations.

After the termination criterion is satisfied, the merging engine 202 can select a particular candidate brain hybridization graph from all the candidate graphs generated over the plurality of iterations based on the similarity measures. For example, the engine 202 can select the graph with the highest similarity measure as the output (e.g., final) brain hybridization graph 206.

A few techniques of generating brain hybridization graphs, each representing a combination of a region of the first biological organism brain, and a region of the second biological organism brain, are described above. In particular, the merging engine 202 can use any of the above techniques in any combination to generate any number of brain hybridization graphs 206, each representing the brain of any number and type of biological organisms that can be the same, or different organisms.

After generating candidate brain hybridization graphs 206, the architecture mapping engine 208 can process each candidate brain hybridization graph 206 to generate a corresponding candidate brain hybridization neural network architecture 210. For example, the architecture mapping engine 208 can map each node in the candidate graph 206 to a corresponding: (i) artificial neuron, (ii) artificial neural network layer, or (iii) group of artificial neural network layers in the candidate architecture 210. An example process that can be performed by the architecture mapping engine 208 will be described in more detail below with reference to FIG. 9.

For each candidate brain hybridization neural network architecture 210, the training engine 212 can instantiate a candidate neural network, e.g., the neural network 602 described below with reference to FIG. 6. The candidate neural network can include: (i) one or more brain hybridization sub-networks, each of which can be specified by a respective candidate brain hybridization architecture 210, and (ii) one or more other neural network layers, e.g., fully-connected layers, convolutional layers, attention layers, or any other appropriate layers.

Generally, the training engine 212 can instantiate multiple candidate neural networks having any appropriate configuration. In one example, the training engine 212 can instantiate a candidate neural network having multiple copies of the same brain hybridization neural network architecture 210. In another example, the training engine 212 can instantiate a candidate neural network having multiple different brain hybridization neural network architectures 210, e.g., each brain hybridization neural network architecture 210 being specified by a different brain hybridization graph 206. The training engine 212 can instantiate any appropriate number and configuration of the candidate neural networks, including any appropriate number and configuration of brain hybridization neural network architectures 210, and evaluate each candidate neural network at the same machine learning task, as will be described in more detail next.

Each candidate neural network is configured to perform the machine learning task, e.g., by processing a network input to generate a corresponding network output that defines a prediction for the network input. The machine learning task can be any appropriate machine learning task, e.g., a classification task, a regression task, a segmentation task, an agent control task, or a combination thereof. The training engine 212 is configured to train each candidate neural network over multiple training iterations.

The training engine 212 determines a respective performance measure 214 of each candidate neural network (e.g., of each candidate brain hybridization neural network architecture 210) on the machine learning task. For example, the training engine 214 can train each candidate neural network on a set of training data over a sequence of training iterations, e.g., as described with reference to FIG. 6. The training engine 212 can then evaluate the performance of each candidate neural network on a set of validation data, e.g., that includes a set of training examples that are part of the training data used to train the candidate neural network. The training engine 212 can evaluate the performance of each candidate neural network based on the set of validation data, e.g., by computing an average error (e.g., cross-entropy error or squared-error) in network outputs generated by each candidate neural network for the validation data.

The selection engine 216 can select the brain hybridization neural network architecture 218 for performing the machine learning task based on the performance measures 214. In one example, the selection engine 216 can select the candidate brain hybridization neural network architecture 210 that has the best (e.g., the highest) performance measure 214, and provide the candidate architecture as the output brain hybridization neural network architecture 218.

An example sub-graph selection system, that can select one or more sub-graphs 202 of one or more synaptic connectivity graphs, which can be combined by the merging system 200 to generate the brain hybridization neural network architecture 218, will be described in more detail next.

FIG. 3 is a block diagram of an example sub-graph selection system 300 that can select one or more sub-graphs 316 of a synaptic connectivity graph 301. The sub-graph selection system 300 is an example of a system implemented as computer programs on one or more computers in one or more locations in which the systems, components, and techniques described below are implemented.

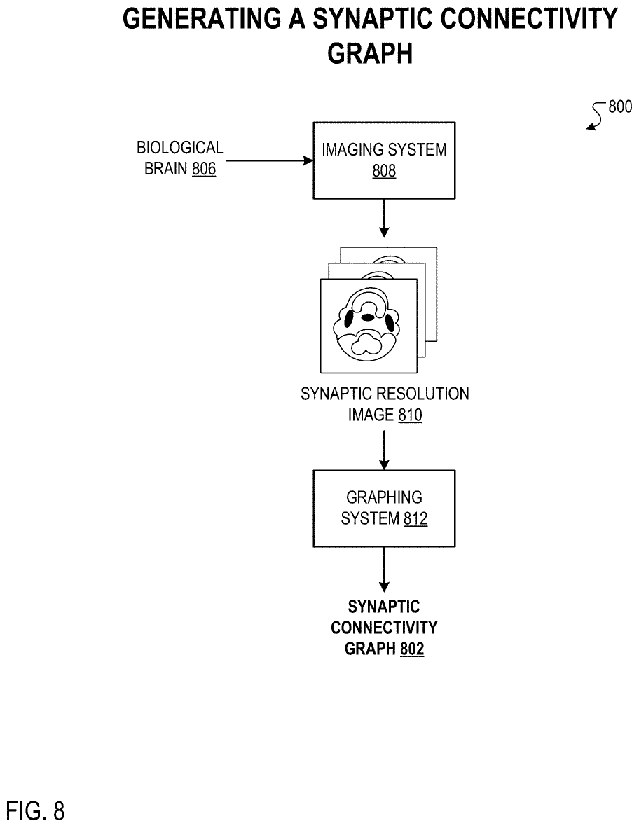

As described above with reference to FIG. 1, the synaptic connectivity graph 301 can represent synaptic connectivity between biological neuronal elements in the brain of a biological organism. The graph 301 can be obtained from a synaptic resolution image of the brain, e.g., as described in more detail below with reference to FIG. 8. The system 300 can process data defining the synaptic connectivity graph 301 and select one or more sub-graphs 316 of the synaptic connectivity graph 301.

In some implementations, the system 300 can process multiple synaptic connectivity graphs 301, each representing a respective biological organism brain, and select one or more sub-graphs 316 from each of the synaptic connectivity graphs 301. The sub-graphs 316 can be combined by a merging system (e.g., the merging system 200 in FIG. 2) to generate one or more brain hybridization graphs (e.g., the graphs 206). Each brain hybridization graph can represent a combination of a region of a first biological organism brain, and a region of a second biological organism brain.

Based on the brain hybridization graphs, the merging system can generate a brain hybridization neural network architecture (e.g., the architecture 218 in FIG. 2) that can, e.g., inherit unique capabilities of different biological organisms to perform a task. As will be described in more detail below with reference to FIG. 6, the architecture can be instantiated as part of a neural network and used to perform the task.

The sub-graph selection system 300 can include: (i) a transformation engine 304, (ii) a feature generation engine 306, (iii) a node classification engine 308, and (iv) a nucleus classification engine 318, each of which will be described in more detail next.

The transformation engine 304 can be configured to apply one or more transformation operations to the synaptic connectivity graph 301 that can alter the connectivity of the graph 301, i.e., by adding or removing edges from the graph. A few examples of transformation operations follow.

In one example, to apply a transformation operation to the graph 301, the transformation engine 304 can randomly sample a set of node pairs from the graph (i.e., where each node pair specifies a first node and a second node). For example, the transformation engine 304 can sample a predefined number of node pairs in accordance with a uniform probability distribution over the set of possible node pairs. For each sampled node pair, the transformation engine 304 can modify the connectivity between the two nodes in the node pair with a predefined probability (e.g., 0.1%). In one example, the transformation engine 304 can connect the nodes by an edge (i.e., if they are not already connected by an edge) with the predefined probability. In another example, the transformation engine 304 can reverse the direction of any edge connecting the two nodes with the predefined probability. In another example, the transformation engine 304 can invert the connectivity between the two nodes with the predefined probability, i.e., by adding an edge between the nodes if they are not already connected, and by removing the edge between the nodes if they are already connected.

In another example, the transformation engine 304 can apply a convolutional filter to a representation of the graph 301 as a two-dimensional array of numerical values. As described above, the graph 301 can be represented as a two-dimensional array of numerical values where the component of the array at position (i,j) can have value 1 if the graph includes an edge pointing from node i to node j, and value 0 otherwise. The convolutional filter can have any appropriate kernel, e.g., a spherical kernel or a Gaussian kernel. After applying the convolutional filter, the transformation engine 304 can quantize the values in the array representing the graph, e.g., by rounding each value in the array to 0 or 1, to cause the array to unambiguously specify the connectivity of the graph. Applying a convolutional filter to the representation of the graph 301 can have the effect of regularizing the graph, e.g., by smoothing the values in the array representing the graph to reduce the likelihood of a component in the array having a different value than many of its neighbors.

In some cases, the graph 301 can include some inaccuracies in representing the synaptic connectivity in the biological brain. For example, the graph can include nodes that are not connected by an edge despite the corresponding neuronal elements in the brain being biologically connected, or “spurious” edges that connect nodes in the graph despite the corresponding neuronal elements in the brain not being connected by a biological connection. Inaccuracies in the graph can result, e.g., from imaging artifacts or ambiguities in the synaptic resolution image of the brain that is processed to generate the graph. Regularizing the graph, e.g., by applying a convolutional filter to the representation of the graph, can increase the accuracy with which the graph represents the synaptic connectivity in the brain, e.g., by removing spurious edges.

The sub-graph selection system 300 can use the feature generation engine 306 and the node classification engine 308 to determine predicted “types” 310 of the neuronal elements corresponding to the nodes in the graph 301. The type of a neuronal element can characterize any appropriate aspect of the neuronal element. In one example, the type of a neuronal element can characterize the function performed by the neuronal element in the brain, e.g., a visual function by processing visual data, an olfactory function by processing odor data, or a memory function by retaining information. After identifying the types of the neuronal elements corresponding to the nodes in the graph 301, the sub-graph selection system 300 can identify one or more sub-graphs 316 of the overall graph 301 based on the neuronal element types. The feature generation engine 306 and the node classification engine 308 are described in more detail next.

The feature generation engine 306 can be configured to process the graph 301 (potentially after it has been modified by the transformation engine 304) to generate one or more respective node features 314 corresponding to each node of the graph 301. The node features corresponding to a node can characterize the topology (i.e., connectivity) of the graph relative to the node. In one example, the feature generation engine 306 can generate a node degree feature for each node in the graph 301, where the node degree feature for a given node specifies the number of other nodes that are connected to the given node by an edge.

In another example, the feature generation engine 306 can generate a path length feature for each node in the graph 301, where the path length feature for a node specifies the length of the longest path in the graph starting from the node. A path in the graph can refer to a sequence of nodes in the graph, such that each node in the path is connected by an edge to the next node in the path. The length of a path in the graph can refer to the number of nodes in the path.

In another example, the feature generation engine 306 can generate a neighborhood size feature for each node in the graph 301, where the neighborhood size feature for a given node specifies the number of other nodes that are connected to the node by a path of length at most N. In this example, N can be a positive integer value.

In another example, the feature generation engine 306 can generate an information flow feature for each node in the graph 301. The information flow feature for a given node can specify the fraction of the edges connected to the given node that are outgoing edges, i.e., the fraction of edges connected to the given node that point from the given node to a different node.

In some implementations, the feature generation engine 306 can generate one or more node features that do not directly characterize the topology of the graph relative to the nodes. In one example, the feature generation engine 306 can generate a spatial position feature for each node in the graph 301, where the spatial position feature for a given node specifies the spatial position in the brain of the neuronal element corresponding to the node, e.g., in a Cartesian coordinate system of the synaptic resolution image of the brain. In another example, the feature generation engine 306 can generate a feature for each node in the graph 301 indicating whether the corresponding neuronal element (e.g., a neuron) is excitatory or inhibitory. In another example, the feature generation engine 306 can generate a feature for each node in the graph 301 that identifies the neuropil region associated with the neuronal element corresponding to the node.

In some cases, the feature generation engine 306 can use weights associated with the edges in the graph in determining the node features 314. Generally, a weight value for an edge connecting two nodes can be determined, e.g., based on the area of any overlap between tolerance regions around the neuronal elements corresponding to the nodes. In one example, the feature generation engine 306 can determine the node degree feature for a given node as a sum of the weights corresponding to the edges that connect the given node to other nodes in the graph. In another example, the feature generation engine 306 can determine the path length feature for a given node as a sum of the edge weights along the longest path in the graph starting from the node.

The node classification engine 308 can be configured to process the node features 314 to identify a predicted neuronal element type 310 corresponding to certain nodes of the graph 301. In one example, the node classification engine 308 can process the node features 314 to identify a proper subset of the nodes in the graph 301 with the highest values of the path length feature. For example, the node classification engine 308 can identify the nodes with a path length feature value greater than the 90th percentile (or any other appropriate percentile) of the path length feature values of all the nodes in the graph.

The node classification engine 308 can then associate the identified nodes having the highest values of the path length feature with the predicted neuronal element type of, e.g., “primary sensory neuron.” In another example, the node classification engine 308 can process the node features 314 to identify a proper subset of the nodes in the graph 301 with the highest values of the information flow feature, i.e., indicating that many of the edges connected to the node are outgoing edges. The node classification engine 308 can then associate the identified nodes having the highest values of the information flow feature with the predicted neuronal element type of, e.g., “sensory neuron.” In another example, the node classification engine 308 can process the node features 314 to identify a proper subset of the nodes in the graph 301 with the lowest values of the information flow feature, i.e., indicating that many of the edges connected to the node are incoming edges (i.e., edges that point towards the node). The node classification engine 308 can then associate the identified nodes having the lowest values of the information flow feature with the predicted neuronal element type of, e.g., “associative neuron.”

The sub-graph selection system 300 can identify one or more sub-graphs 316 of the overall synaptic connectivity graph 301 (or multiple synaptic connectivity graphs, each representing a respective biological organism brain) based on the predicted neuronal element types 310 corresponding to the nodes of the graph 301. A “sub-graph” can refer to a graph specified by: (i) a proper subset of the nodes of the graph 301, and (ii) a proper subset of the edges of the graph 301. FIG. 4 provides an illustration of example sub-graphs, each derived from a different synaptic connectivity graph 301.

In one example, the sub-graph selection system 300 can select: (i) each node in the graph 301 corresponding to particular neuron type, and (ii) each edge in the graph 301 that connects nodes in the graph corresponding to the particular neuron type, for inclusion in the sub-graph 316. The neuron type selected for inclusion in the sub-graph can be, e.g., visual neurons, olfactory neurons, memory neurons, or any other appropriate type of neuron. In some cases, the sub-graph selection system 300 can select multiple neuronal element types for inclusion in the sub-graph 316, e.g., both visual neurons and olfactory neurons.

As described above with reference to FIG. 2, the sub-graphs 316 can be combined by the merging system to generate the brain hybridization graph. The brain hybridization graph can specify the architecture of the brain hybridization neural network. The type of neuronal element selected for inclusion in the sub-graphs 316 can be determined based on the task which the brain hybridization neural network will be configured to perform. In some implementations, the brain hybridization neural network can be configured to perform an image processing task, and neuronal elements that are predicted to perform visual functions (i.e., by processing visual data) can be selected for inclusion in the sub-graphs 316. For example, the system 300 can process multiple synaptic connectivity graphs 301, each representing a respective biological organism brain, and select a sub-graph from each of the graphs 301 that represents neuronal elements that are predicted to perform visual functions. Other functions of neuronal elements can include, e.g., odor processing, audio processing, and any other appropriate functions.

If the edges of the graph 301 are associated with weight values (as described above), then each edge of the sub-graph 316 can be associated with the weight value of the corresponding edge in the graph 301.

In some cases, the sub-graph selection system 300 can process a representation of the synaptic connectivity graph 301 as a two-dimensional array of numerical values (as described above) to identify one or more “clusters” in the array. A cluster in the array representing the graph can refer to a contiguous region of the array such that at least a threshold fraction of the components in the region have a value indicating that an edge exists between the pair of nodes corresponding to the component. In one example, the component of the array in position (i,j) can have value 1 if an edge exists from node i to node j, and value 0 otherwise. In this example, the nucleus classification engine 318 can identify contiguous regions of the array such that at least a threshold fraction of the components in the region have the value 1.

The nucleus classification engine 318 can identify clusters in the array representing the graph 301 by processing the array using a blob detection algorithm, e.g., by convolving the array with a Gaussian kernel and then applying the Laplacian operator to the array. After applying the Laplacian operator, the nucleus classification engine 318 can identify each component of the array having a value that satisfies a predefined threshold as being included in a cluster.

Each of the clusters identified in the array representing the graph 301 can correspond to edges connecting a “nucleus” (i.e., group) of related neuronal elements in brain, e.g., a thalamic nucleus, a vestibular nucleus, a dentate nucleus, or a fastigial nucleus. After the nucleus classification engine 318 identifies the clusters in the array representing the graph, the sub-graph selection system 300 can select one or more of the clusters for inclusion in the sub-graph 316. The sub-graph selection system 300 can select the clusters for inclusion in the sub-graph 316 based on respective features associated with each of the clusters. The features associated with a cluster can include, e.g., the number of edges (i.e., components of the array) in the cluster, the average of the node features corresponding to each node that is connected by an edge in the cluster, or both. In one example, the sub-graph selection system 300 can select a predefined number of largest clusters (i.e., that include the greatest number of edges) for inclusion in one or more sub-graphs 316.

As described above, the sub-graphs 316, generated by the selection system 300, can be combined by the merging system to generate the brain hybridization graph. Example sub-graphs 316, and example brain hybridization graph, will be described in more detail next.

FIG. 4 illustrates an example brain hybridization graph 440 (e.g., the brain hybridization graph 150 in FIG. 1) generated by a merging engine 420 (e.g., the merging engine 204 in FIG. 2). As described above, the merging engine 420 can combine multiple sub-graphs 416 (e.g., sub-graphs 316 in FIG. 3) to generate the brain hybridization graph 440. Although only a first sub-graph and a second sub-graph are illustrated in FIG. 4, the merging engine 420 can combine any number of sub-graphs 416 to generate the brain hybridization graph 440.

As described above with reference to FIG. 3, a sub-graph selection system can process the synaptic connectivity graph to generate the sub-graphs 416. In some implementations, the selection system can process multiple synaptic connectivity graphs, each representing a respective biological organism brain, and select a sub-graph from each of the graphs. Accordingly, the brain hybridization graph 440 can represent a combination of a region of a first biological organism brain, and a region of a second biological organism brain, which can be of the same biological organism, or different biological organisms.

As illustrated in FIG. 4, the nodes included in the first sub-graph are represented by empty circles 406, and the edges included in the first sub-graph are represented by dashed lines 408. The nodes included in the second sub-graph are represented by filled circles 410 and the edges included in the second sub-graph are represented by dashed lines 412. The merging engine 420 can process the first sub-graph and the second sub-graph to generate the brain hybridization graph 440.

As described above with reference to FIG. 2, in some implementations, the merging engine 420 can concatenate, or linearly combine, a weight matrix of the first sub-graph and a weight matrix of the second sub-graph, to generate the brain hybridization graph 440. In some implementations, the merging engine 420 can generate the brain hybridization graph 440 by iteratively evolving it under constraints of similarity to the second sub-graph.

As illustrated in FIG. 4, the brain hybridization graph includes nodes 404 represented by dashed circles, and edges 402 represented by solid lines. In other words, the brain hybridization graph 440 can represent a combination of a region of the first biological organism brain, represented by the first sub-graph, and a region of the second biological organism brain, represented by the second sub-graph.

As described above, the brain hybridization graph 440 can be represented by a weight matrix. Example weight matrices of brain hybridization graphs will be described in more detail next.

FIG. 5A illustrates an example weight matrix 501 of a sub-graph of a synaptic connectivity graph (e.g., a first sub-graph of the first synaptic connectivity graph 130 in FIG. 1).

As described in more detail below with reference to FIG. 8, a graphing system (e.g., the graphing system 812 in FIG. 8), can generate the synaptic connectivity graph that represents synaptic connectivity between biological neuronal elements in the brain of a biological organism. Generally, the synaptic connectivity graph can be represented using a two-dimensional array of numerical values (e.g., an adjacency matrix 500) with a number of rows and columns equal to the number of nodes in the synaptic connectivity graph. As described in more detail above with reference to FIG. 2, a sub-graph selection system can select a sub-graph from the synaptic connectivity graph. The sub-graph can be represented using a portion of the adjacency matrix, e.g., the weight matrix 501. Each sub-graph can be represented by a respective weight matrix.

As described in more detail above with reference to FIG. 3, a merging system can combine multiple sub-graphs, e.g., based on their respective weight matrix representations, to generate a weight matrix that represents the brain hybridization graph.

The weight matrix 501 can specify the brain hybridization parameters of a neural network architecture that is specified by the brain hybridization graph (e.g., the brain hybridization neural network, or sub-network).

As illustrated in FIG. 5A, the weight matrix 501 includes n² elements, where n is the number of biological neuronal elements drawn from a region of the brain of the biological organism, the region of the brain being represented by the sub-graph of the synaptic connectivity graph. For example, the weight matrix 501 can include hundreds, thousands, tens of thousands, hundreds of thousands, millions, tens of millions, or hundreds of millions of elements. As a particular example, the number of elements n can equal the number of nodes in the brain hybridization graph.

Each element of the weight matrix 501 represents connectivity between a respective pair of neuronal elements in the set of n neuronal elements. That is, each element c_{i,j} identifies the biological connection between, e.g., neuronal element i and neuronal element j. In some implementations, each of the elements c_{i,j} are either zero (e.g., indicating that there is no biological connection between the corresponding neuronal elements) or one (e.g., indicating that there is a biological connection between the corresponding neuronal elements). In some implementations, each element c_{i,j} is a scalar value representing the strength of the biological connection between the corresponding neuronal elements.

Each row of the weight matrix 501 can represent a respective neuronal element in a first set of neuronal elements in the brain of the biological organism, and each column of the weight matrix 501 can represent a respective neuronal element in a second set in the brain of the biological organism. Generally, the first set and the second set can be overlapping, or disjoint. In some implementations, the first set and the second set can be the same.

In implementations where the sub-graph of the synaptic connectivity graph is undirected (e.g., where the edges in the graph are not associated with a direction), the weight matrix 501 is symmetric (i.e., each element c_{i,j} is the same as element c_{j,i}). In implementations where the sub-graph is directed (e.g., where each edge in the graph is associated with a direction that can correspond to, e.g., the direction of the synapse that the edge represents), the weight matrix 501 is not symmetric (i.e., there may exist elements c_{i,j} and c_{j,i} such that c_{i,j}≠c_{j,i}).

The above example is provided for illustrative purposes only, and generally the elements of the weight matrix 501 can correspond to pairs of any appropriate type of neuronal element in the brain of the biological organism. For example, each element can correspond to a pair of voxels in a voxel grid of the brain of the biological organism. As another example, each element can correspond to a pair of sub-neurons, or parts of neurons, in the brain of the biological organism. As another example, each element can correspond to a pair of sets of multiple neurons in the brain of the biological organism.

Although the weight matrix 501 of the sub-graph is illustrated as having only a few brain hybridization parameters, the weight matrix 501 can generally have significantly more parameters, e.g., hundreds, thousands, or millions of brain hybridization parameters. Further, the weight matrix 501 can have any appropriate dimensionality.

FIG. 5B illustrates an example of linearly combining a first weight matrix 501 and a second weight matrix 502 to generate a weight matrix 503 representing a brain hybridization graph.

As described above with reference to FIG. 2, a merging engine (e.g., the merging engine 204 in FIG. 2) can combine multiple sub-graphs (e.g., sub-graphs 416 in FIG. 4) of multiple respective synaptic connectivity graphs to generate a brain hybridization graph (e.g., the graph 440 in FIG. 4). The merging engine can combine the sub-graphs based on their respective weight matrix representations. For example, as illustrated in FIG. 5B, the merging engine can combine the first weight matrix 501, representing the first sub-graph, and the second weight matrix 502, representing the second sub-graph, to generate the weight matrix 503 representing the brain hybridization graph. In this case, the weight matrix 503 can have the same number of dimensions as the first weight matrix 501 and the second weight matrix.

FIG. 5C illustrates an example of concatenating a first weight matrix 501 and a second weight matrix 502 to generate a weight matrix 503 representing a brain hybridization graph.

As described above with reference to FIG. 2, a merging engine (e.g., the merging engine 204 in FIG. 2) can vertically, or horizontally, concatenate the first weight matrix 501, representing the first sub-graph, and the second weight matrix 502, representing the second sub-graph, to generate the weight matrix 503 representing the brain hybridization graph. FIG. 5C illustrates the first weight matrix 501 and the second weight matrix 502 being vertically concatenated. In this case, the number of columns of the weight matrix 503 can be the same as the number of columns of the first weight matrix 501 and the second weight matrix 502, while the number of rows of the weight matrix 503 can be a sum of the rows of the first weight matrix 501 and the second weight matrix 502.

FIG. 5D illustrates example evolutionary hybridization 520 of a first weight matrix 501 and a second weight matrix 502 to generate a weight matrix 503 representing a brain hybridization graph.

As described above with reference to FIG. 2, a merging engine (e.g., the merging engine 204 in FIG. 2) can initialize the first sub-graph, represented by the first weight matrix 501, as the brain hybridization graph, and iteratively evolve the brain hybridization graph under constraints of similarity to the second sub-graph, represented by the second weight matrix 502. In this case, the weight matrix 503 representing the brain hybridization graph, can have any number of rows and any number of columns.

FIG. 6 is a block diagram of an example neural network computing system 600 that includes a neural network having an architecture that is specified by a brain hybridization graph 640 (e.g., a brain hybridization sub-network 630). The neural network computing system 600 is an example of a system implemented as computer programs on one or more computers in one or more locations in which the systems, components, and techniques described below are implemented.

As described above with reference to FIG. 2, the brain hybridization graph 640 can be a combination of a first sub-graph, representing connectivity between biological neuronal elements in a first biological organism brain, and a second sub-graph, representing connectivity between biological neuronal elements in a second biological organism brain. The first biological organism brain and the second biological organism brain can be of the same organism, or different organisms. Accordingly, the brain hybridization sub-network 630, having an architecture specified by the graph 640, can represent, e.g., a combination of processing capabilities of different biological organisms.

The neural network computing system 600 can be implemented as a neural network 602 that includes multiple sub-networks: (i) an encoder 610 (ii) the brain hybridization sub-network 630, and (iii) a decoder 650. The neural network 602 is configured to process a network input 604 to generate a network output 606 that defines a prediction for the network input 604. The network input 604 can be any kind of digital data input, and the network output 606 can be any kind of score, classification, or regression output based on the input. That is, the neural network 602 can be configured for any appropriate machine learning task, e.g., a classification task, a regression task, a segmentation task, an agent control task, a combination thereof, or any other appropriate task.

The encoder 610 is configured to process the network input 604 to generate an encoded representation of the network input, e.g., an embedding of the network input. Generally, an “embedding” refers to an ordered collection of numerical values such as, e.g., a vector or a matrix of numerical values. The encoder 610 can include one or more trained neural network layers, e.g., fully-connected layers, convolutional layers, attention layers, or any other appropriate layers. In some implementations, in addition to the one or more trained neural network layers, the encoder 610 can include one or more brain hybridization sub-networks (e.g., sub-networks having an architecture that is specified by one or more respective brain hybridization graphs).

The embedding of the network input can be provided to the brain hybridization sub-network 630 as the brain hybridization sub-network input 622. The brain hybridization sub-network 630 can be configured to process the brain hybridization sub-network input 622 to generate a brain hybridization sub-network output 632. The brain hybridization sub-network 630 can have an architecture that is specified by the brain hybridization graph, as described above with reference to FIG. 2.

As described above with reference to FIGS. 5B, 5C, and 5D, the brain hybridization graph can be represented by a weight matrix (e.g., the matrix 503 in FIGS. 5B, 5C, and 5D). The brain hybridization sub-network 630 can apply the weight matrix to the sub-network input 622 to generate the sub-network output 632. Generally “applying” a matrix can refer to, e.g., performing a multiplication with the matrix. Each element of the weight matrix can be a respective brain hybridization parameter of the brain hybridization sub-network 630.

For example, the brain hybridization sub-network input 622 can include an N×1 vector of elements, the weight matrix of the brain hybridization graph (e.g., the weight matrix 503 in FIG. 5B, 5C, or 5D) can be an M×N matrix of elements, and the brain hybridization sub-network output 632 can be an M×1 vector of elements. In some implementations, a non-linear activation function (e.g., ReLU, or sigmoid activation function) can be applied to the result of the matrix multiplication with the weight matrix of the brain hybridization graph.

As described above, the weight matrix of the brain hybridization graph can be generated by combining a first weight matrix (e.g., the first weight matrix 501 in FIGS. 5B, 5C, and 5D) of a first sub-graph of a first synaptic connectivity graph, and a second weight matrix (e.g., the second weight matrix 502 in FIGS. 5B, 5C, and 5D) of a second sub-graph of a second synaptic connectivity graph. The first weight matrix and the second weight matrix can specify brain hybridization parameters. Each brain hybridization parameter of the respective weight matrix can correspond to a pair of biological neuronal elements (e.g., neurons, groups of neurons, or portions of neurons) in the respective biological organism brain, where the value of the brain hybridization parameter characterizes a strength of a biological connection between the pair of respective biological neuronal elements.

In other words, each row and column of the weight matrix (e.g., the first weight matrix or the second weight matrix) can correspond to a respective biological neuronal element, and the value of each brain hybridization parameter can characterize a strength of a biological connection between (i) the neuronal element corresponding to the row of the brain hybridization parameter and (ii) the neuronal element corresponding to the column of the brain hybridization parameter.

For example, the weight matrix can be an M×N matrix, where each of the M rows corresponds to a neuronal element in a first set of neuronal elements and each of the N columns corresponds to a neuronal element in a second set of neuronal elements. The first set of neuronal elements and the second set of neuronal elements can be overlapping (i.e., one or more neuronal elements can be included in both sets) or disjoint (i.e., where no neuronal elements are included in both sets). As a particular example, the first set and the second set can be the same. That is, the weight matrix can be an N×N matrix where the same neuronal elements are represented by both the rows and the columns of the weight matrix.

The decoder 650 of the neural network 602 is configured to process the brain hybridization sub-network output 632 to generate the network output 606. The decoder 650 can include one or more trained neural network layers, e.g., fully-connected layers, convolutional layers, attention layers, or any other appropriate layers.

In some implementations, in addition to the one or more trained neural network layers, the decoder 650 can include one or more brain hybridization sub-networks (e.g., sub-networks having an architecture that is determined by one or more respective brain hybridization graphs). In some implementations, in addition to processing the brain hybridization sub-network output 632 generated by the brain hybridization sub-network 630, the decoder sub-network 550 can additionally process one or more intermediate outputs of the brain hybridization sub-network 630.

As described above with reference to FIG. 2, each of the sub-graphs included in the brain hybridization graph 640 can have an associated mixing factor. The mixing factor can be, e.g., a numerical value that, when multiplied with a weight matrix representing a sub-graph, can modify the elements of the weight matrix by an amount equal to the numerical value. In other words, the mixing factor can, e.g., artificially increase the strength of connections between biological neuronal elements represented by the weight matrix.

In some implementations, the neural network 602 can include one or more auxiliary neural network layers, e.g., fully-connected layers, convolutional layers, attention layers, or any other appropriate layers, that can generate the mixing factor for each of the sub-graphs included in the brain hybridization graph 640. For example, the auxiliary neural network layers can process the network input 604 and generate an output that defines the respective mixing factor for each of the sub-graphs. The output can be, e.g., a projection of the network input 604 onto a numerical value. In some implementations, the auxiliary neural network layers can process one or more intermediate outputs of the neural network 602, e.g., an output generated by a hidden layer of the encoder sub-network 610. The mixing factor can be a predetermined hyper-parameter of the neural network 602. By dynamically determining the mixing factor, the neural network 602 can automatically prioritize each of sub-graphs based on the network input and the particular machine learning task performed by the neural network 602. In other words, the neural network 602 can automatically prioritize the cognitive abilities of different biological organisms, represented by the sub-graphs, according to the particular machine learning task.

The neural network 602 can have any appropriate neural network architecture that allows it to perform its described function. In some implementations, the neural network 602 can be an autoencoder neural network, where the encoder sub-network 610 is the encoder of the autoencoder and the decoder sub-network 650 is the decoder of the autoencoder. For example, the neural network 602 can be an autoencoder neural network that is configured to generate an embedding of the network input 604 (e.g., using the encoder sub-network 610, where the embedding is the brain hybridization sub-network input 622) and process the embedding to reconstruct the network input (e.g., using the decoder sub-network 650, where the network output 606 is a predicted reconstruction of the network input 604). For example, the neural network 602 can be a variational autoencoder that models the latent space of the generated embeddings using a mixture of distributions.

The neural network computing system 600 can further include a training engine that is configured to train the neural network 602.

In some implementations, the model parameters of the brain hybridization sub-network 630 are untrained. Instead, the model parameters of the brain hybridization sub-network 630 can be determined before training of the neural network 602 based on the weight values of the edges in the brain hybridization graph. Optionally, the weight values of the edges in the hybridization graph can be transformed (e.g., by additive random noise) prior to being used for specifying model parameters of the brain hybridization sub-network 630. This procedure enables the neural network 602 to take advantage of the information from the brain hybridization graph encoded into the brain hybridization sub-network 630 in performing prediction tasks.

Therefore, rather than training the entire neural network 602 from end-to-end, the training engine can optionally train only the model parameters of the encoder sub-network 610 and the decoder sub-network 550, while leaving the model parameters of the brain hybridization sub-network 630 fixed during training. In other words, the model parameters of one or more of the respective brain hybridization sub-networks 630 included in the neural network 602 can be left untrained while training some or all of the other parameters of the neural network 602.

The training engine can train the neural network 602 on a set of training data over multiple training iterations. The training data can include a set of training examples, where each training example specifies: (i) a training network input, and (ii) a target network output that should be generated by the neural network 602 by processing the training network input.

At each training iteration, the training engine can sample a batch of training examples from the training data, and process the training inputs specified by the training examples using the neural network 602 to generate corresponding network outputs 606. In particular, for each training input, the neural network 602 processes the training input using the current model parameter values of the encoder 610 to generate the brain hybridization sub-network input 622.

The neural network 602 processes the brain hybridization sub-network input 622 in accordance with the static model parameter values of the brain hybridization sub-network 630 to generate the brain hybridization sub-network output 632. The neural network 602 then processes the brain hybridization sub-network output 632 using the current model parameter values of the decoder sub-network 650 to generate the network output 606 corresponding to the training input.

The training engine adjusts the model parameters values of the encoder sub-network 610 and the model parameter values of the decoder sub-network 650 to optimize an objective function that measures a similarity between: (i) the network outputs 606 generated by the neural network 602, and (ii) the target network outputs specified by the training examples. The objective function can be, e.g., a cross-entropy objective function, a squared-error objective function, or any other appropriate objective function.

To optimize the objective function, the training engine can determine gradients of the objective function with respect to the model parameters of the encoder 610 and the model parameters of the decoder 650, e.g., using backpropagation techniques. The training engine can then use the gradients to adjust the model parameter values of the encoder 610 and the decoder 650, e.g., using any appropriate gradient descent optimization technique, e.g., an RMSprop or Adam gradient descent optimization technique.

The training engine can use any of a variety of regularization techniques during training of the neural network 602. For example, the training engine can use a dropout regularization technique, such that certain artificial neurons of the neural network 602 are “dropped out” (e.g., by having their output set to zero) with a non-zero probability p>0 each time the neural network 602 processes a network input. Using the dropout regularization technique can improve the performance of the trained neural network 602, e.g., by reducing the likelihood of over-fitting. As another example, the training engine can regularize the training of the neural network 602 by including a “penalty” term in the objective function that measures the magnitude of the model parameter values of the encoder 610 and the decoder 650. The penalty term can be, e.g., an L1 or L2 norm of the model parameter values of the encoder 610 and/or the model parameter values of the decoder 650.

In some other implementations, the model parameters of the brain hybridization sub-network 630 are trained. That is, after initial values for the model parameters of the brain hybridization sub-network 630 have been determined based on the weight values of the edges in the brain hybridization graph, the training engine can update the weights of the model parameters, as described above with reference to the parameters of the encoder 610 and the decoder 650, e.g., using backpropagation and stochastic gradient descent.

The neural network 602 can be configured to perform any appropriate task. A few examples follow.

In one example, the neural network 602 can be configured to process network inputs 604 that represent sequences of audio data. For example, each input element in the network input 604 can be a raw audio sample or an input generated from a raw audio sample (e.g., a spectrogram), and the neural network 602 can process the sequence of input elements to generate network outputs 606 representing predicted text samples that correspond to the audio samples. That is, the neural network 602 can be a “speech-to-text” neural network.

As another example, each input element can be a raw audio sample or an input generated from a raw audio sample, and the neural network 602 can generate a predicted class of the audio samples, e.g., a predicted identification of a speaker corresponding to the audio samples. As a particular example, the predicted class of the audio sample can represent a prediction of whether the input audio example is a verbalization of a predefined work or phrase, e.g., a “wakeup” phrase of a mobile device. In some implementations, the weight matrix of the brain hybridization sub-network 630 can be generated from the brain hybridization graph that includes multiple sub-graphs, where each sub-graph represents connectivity between neuronal elements in an audio region of the brain, i.e., a region of the brain that processes auditory information (e.g., the auditory cortex). For example, the brain hybridization graph can include a first sub-graph that represents the audio region of a first biological organism brain, and a second sub-graph that represents the audio region of a second, different, biological organism brain.

As another example, the neural network 602 can be configured to process network inputs that represent sequences of text data. For example, each input element in the network input can be a text sample (e.g., a character, phoneme, or word) or an embedding of a text sample, and the neural network 602 can process the sequence of input elements to generate network outputs representing predicted audio samples that correspond to the text samples. That is, the neural network can be a “text-to-speech” neural network.

As another example, each input element can be an input text sample or an embedding of an input text sample, and the neural network can generate a network output representing a sequence of output text samples corresponding to the sequences of input text samples. As a particular example, the output text samples can represent the same text as the input text samples in a different language (i.e., the neural network can be a machine translation neural network). As another particular example, the output text samples can represent an answer to a question posed by the input text samples (i.e., the neural network can be a question-answering neural network).

As another example, the input text samples can represent two texts (e.g., as separated by a delimiter token), and the neural network can generate a network output representing a predicted similarity between the two texts. In some implementations, the weight matrix of the brain hybridization sub-network 630 can be generated from the brain hybridization graph that includes multiple sub-graphs, where each sub-graph represents connectivity between neuronal elements in a speech region of the brain, i.e., a region of the brain that is linked to speech production (e.g., Broca's area). For example, the brain hybridization graph can include a first sub-graph that represents the speech region of a first biological organism brain, and a second sub-graph that represents the speech region of a second, different, biological organism brain.

As another example, the neural network 602 can be configured to process network inputs representing one or more images, e.g., sequences of video frames. For example, each input element in the network input can be a video frame or an embedding of a video frame, and the neural network 602 can process the sequence of input elements to generate a network output representing a prediction about the video represented by the sequence of video frames.

As a particular example, the neural network 602 can be configured to track a particular object in each of the frames of the video, i.e., to generate a network output that includes a sequences of output elements, where each output elements represents a predicted location within a respective video frames of the particular object.

As another example, the neural network 602 can be configured to process a video to generate a classification of the video in a class from a predetermined set of classes. The classes can be, e.g., action classes, where each action class corresponds to a possible type of action (e.g., sitting, standing, walking, etc.), and a video is classified as being included in the action class if the video shows a person performing the action corresponding to the action class. In some implementations, the brain hybridization sub-network 208 can be generated from the brain hybridization graph that includes multiple sub-graphs, where each sub-graph represents connectivity between neuronal elements in a visual region of the brain, i.e., a region of the brain that processes visual information (e.g., the visual cortex). For example, the brain hybridization graph can include a first sub-graph that represents the visual region of a first biological organism brain, and a second sub-graph that represents the visual region of a second, different, biological organism brain.

As another example, the neural network 602 can be configured to process a network input representing a respective current state of an environment at each of one or more time points, and to generate a network output representing action selection outputs that can be used to select actions to be performed at respective time points by an agent interacting with the environment. For example, each action selection output can specify a respective score for each action in a set of possible actions that can be performed by the agent, and the agent can select the action to be performed by sampling an action in accordance with the action scores. In one example, the agent can be a mechanical agent interacting with a real-world environment to perform a navigation task (e.g., reaching a goal location in the environment), and the actions performed by the agent cause the agent to navigate through the environment.

After training, the neural network 602 can be directly applied to perform prediction tasks. For example, the neural network 602 can be deployed onto a user device. In some implementations, the neural network 602 can be deployed directly into resource-constrained environments (e.g., mobile devices). Neural networks 602 that include brain hybridization sub-networks 630 having an architecture that is specified by the brain hybridization graph can generally perform at a high level, e.g., in terms of prediction accuracy, even with very few model parameters, when compared to other neural networks.

For example, neural networks 602 as described in this specification that have, e.g., 100 or 900 model parameters can achieve comparable performance to other neural networks that have millions of model parameters. Thus, the neural network 602 can be implemented efficiently and with low latency on user devices.

In some implementations, after the neural network 602 has been deployed onto a user device, some of the parameters of the neural network 602 can be further trained, i.e., “fine-tuned,” using new training examples obtained by the user device. For example, some of the parameters can be fine-tuned using training examples corresponding to the specific user of the user device, so that the neural network 602 can achieve a higher accuracy for inputs provided by the specific user. As a particular example, the model parameters of the encoder 610 and/or the decoder 650 can be fine-tuned on the user device using new training examples while the model parameters of the brain hybridization sub-network 630 are held static, as described above.

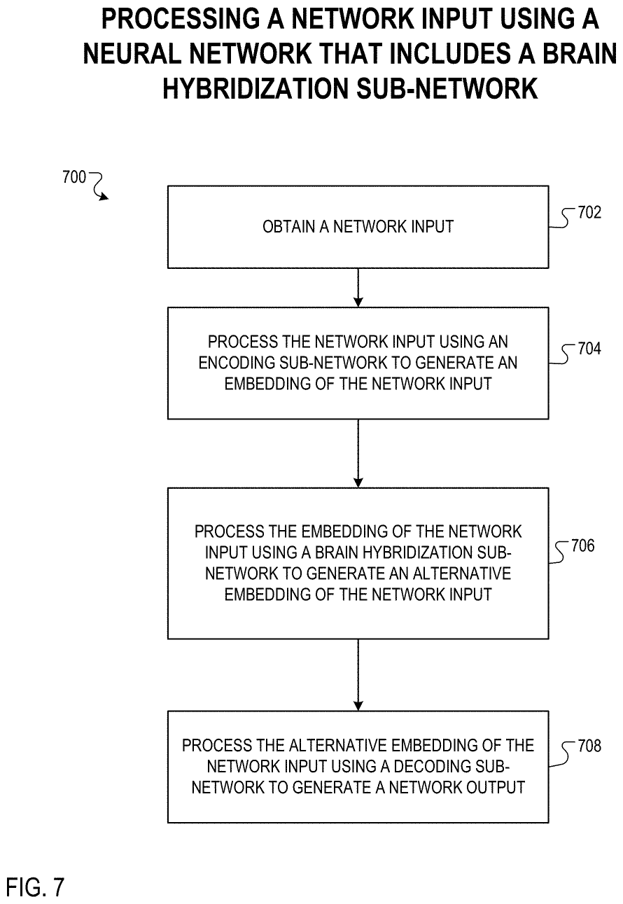

FIG. 7 is a flow diagram of an example process 700 for processing a network input using a neural network (e.g., the neural network 602 in FIG. 6) that includes a brain hybridization sub-network (e.g., the sub-network 630 in FIG. 6) having an architecture that is specified by a brain hybridization graph (e.g., the graph 640 in FIG. 6). For convenience, the process 700 will be described as being performed by a system of one or more computers located in one or more locations. The system can be, e.g., the neural network computing system 600 in FIG. 6.

The system obtains the network input (702).

The system processes the network input using the neural network to generate a network output that defines a prediction related to the network input. For example, the system can process the network input using an encoding sub-network of the neural network to generate an embedding of the network input (704).

The system processes the embedding of the network input using the brain hybridization sub-network of the neural network to generate an alternative embedding of the network input (706). As described in more detail above with reference to FIG. 1, the brain hybridization sub-network can have a neural network architecture that is specified by the brain hybridization graph. As described in more detail above with reference to FIG. 2, the brain hybridization graph can be a combination of: (i) a sub-graph of a first synaptic connectivity graph representing synaptic connectivity between neuronal elements in a first biological organism brain, and (ii) a sub-graph of a second synaptic connectivity graph representing synaptic connectivity between neuronal elements in a second biological organism brain.

The system can process the alternative embedding of the network input using a decoding sub-network of the neural network to generate the network output that defines the prediction related to the network input (708).

In some implementations, the first sub-graph of the first synaptic connectivity graph can be selected based on a set of features that characterize a biological function of the corresponding biological neuronal elements in the first biological organism brain, and the second sub-graph of the second synaptic connectivity graph can be selected based on a set of features that characterize a biological function of the corresponding biological neuronal elements in the second biological organism brain. The biological function of the corresponding biological neuronal elements in the first biological organism brain, and the biological function of the corresponding biological neuronal elements in the second biological organism brain, can be different biological functions.

In some implementations, the first sub-graph can be represented as a first two-dimensional weight matrix of brain emulation parameters. The first matrix can include multiple rows and columns. Each row and each column of the first weight matrix can correspond to a respective biological neuronal element in the first biological organism brain, and each brain emulation parameter in the first weigh matrix can correspond to a respective pair of biological neuronal elements in the first biological organism brain including: (i) the biological neuronal element corresponding to a row of the brain emulation parameter in the first weight matrix, and (ii) the biological neuronal element corresponding to a column of the brain emulation parameter in the first weight matrix. The second sub-graph can be similarly represented as a second two-dimensional weight matrix.

In some implementations, the brain hybridization graph can be defined by a two-dimensional weight matrix, where the weight matrix of the brain hybridization graph can be generated by combining the first weight matrix representing the first sub-graph and the second weight matrix representing the second sub-graph.

FIG. 8 is an example data flow 800 for generating a synaptic connectivity graph 802 based on the brain 806 of a biological organism.

An imaging system 808 can be used to generate a synaptic resolution image 810 of the brain 806. An image of the brain 806 can be referred to as having synaptic resolution if it has a spatial resolution that is sufficiently high to enable the identification of at least some synapses in the brain 806. Put another way, an image of the brain 806 can be referred to as having synaptic resolution if it depicts the brain 806 at a magnification level that is sufficiently high to enable the identification of at least some synapses in the brain 806. The image 810 can be a volumetric image, i.e., that characterizes a three-dimensional representation of the brain 806. The image 810 can be represented in any appropriate format, e.g., as a three-dimensional array of numerical values.

The imaging system 808 can be any appropriate system capable of generating synaptic resolution images, e.g., an electron microscopy system. The imaging system 808 can process “thin sections” from the brain 806 (i.e., thin slices of the brain attached to slides) to generate output images that each have a field of view corresponding to a proper subset of a thin section. The imaging system 808 can generate a complete image of each thin section by stitching together the images corresponding to different fields of view of the thin section using any appropriate image stitching technique. The imaging system 808 can generate the volumetric image 810 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

In some implementations, the imaging system 808 can be a two-photon endomicroscopy system that utilizes a miniature lens implanted into the brain to perform fluorescence imaging. This system enables in-vivo imaging of the brain at the synaptic resolution. Example techniques for generating a synaptic resolution image of the brain using two-photon endomicroscopy are described with reference to: Z. Qin, et al., “Adaptive optics two-photon endomicroscopy enables deep-brain imaging at synaptic resolution over large volumes,” Science Advances, Vol. 6, no. 40, doi: 10.1126/sciadv.abc6521.

A graphing system 812 is configured to process the synaptic resolution image 810 to generate the synaptic connectivity graph 802. The synaptic connectivity graph 802 specifies a set of nodes and a set of edges, such that each edge connects two nodes. To generate the graph 802, the graphing system 812 identifies each neuronal element (e.g., a neuron, a group of neurons, or a part of a neuron) in the image 810 as a respective node in the graph, and identifies each connection between a pair of neuronal elements (e.g., neurons, groups of neurons, or parts of neurons) in the image 810 as an edge between the corresponding pair of nodes in the graph. The graphing system 812 can identify the neuronal elements, and biological connections between them, depicted in the image 810 using any of a variety of techniques. For example, the graphing system 812 can process the image 810 to identify the positions of the neuronal elements depicted in the image 810, and determine whether a biological connection (e.g., a synapse) connects two neuronal elements based on the proximity of the neuronal elements (as will be described in more detail below). In this example, the graphing system 812 can process an input including: (i) the image, (ii) features derived from the image, or (iii) both, using a machine learning model that is trained using supervised learning techniques to identify neuronal elements in images. The machine learning model can be, e.g., a convolutional neural network model or a random forest model. The output of the machine learning model can include a neuronal element probability map that specifies a respective probability that each voxel in the image is included in a neuronal element. The graphing system 812 can identify contiguous clusters of voxels in the neuronal element probability map as being neuronal elements.

Optionally, prior to identifying the neuronal elements from the probability map, the graphing system 812 can apply one or more filtering operations to the probability map, e.g., with a Gaussian filtering kernel. Filtering the probability map can reduce the amount of “noise” in the probability map, e.g., where only a single voxel in a region is associated with a high likelihood of being a neuronal element.

The machine learning model used by the graphing system 812 to generate the probability map can be trained using supervised learning training techniques on a set of training data. The training data can include a set of training examples, where each training example specifies: (i) a training input that can be processed by the machine learning model, and (ii) a target output that should be generated by the machine learning model by processing the training input. For example, the training input can be a synaptic resolution image of a brain, and the target output can be a “label map” that specifies a label for each voxel of the image indicating whether the voxel is included in a neuronal element. The target outputs of the training examples can be generated by manual annotation, e.g., where a person manually specifies which voxels of a training input are included in neuronal elements.

Example techniques for identifying the positions of neuronal elements depicted in the image 810 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system 812 can identify the biological connections connecting the neuronal elements in the image 810 based on the proximity of the neuronal elements. For example, the graphing system 812 can determine that a first neuronal element is connected to a second neuronal element based on the area of overlap between: (i) a tolerance region in the image around the first neuronal element, and (ii) a tolerance region in the image around the second neuronal element. That is, the graphing system 812 can determine whether the first neuronal element and the second neuronal element are connected based on the number of spatial locations (e.g., voxels) that are included in both: (i) the tolerance region around the first neuronal element, and (ii) the tolerance region around the second neuronal element.

For example, the graphing system 812 can determine that two neurons are connected if the overlap between the tolerance regions around the respective neurons includes at least a predefined number of spatial locations (e.g., one spatial location). A “tolerance region” around a neuronal element refers to a contiguous region of the image that includes the neuronal element. For example, the tolerance region around a neuron can be specified as the set of spatial locations in the image that are either: (i) in the interior of the neuron, or (ii) within a predefined distance of the interior of the neuron.

The graphing system 812 can further identify a weight value associated with each edge in the graph 802. For example, the graphing system 812 can identify a weight for an edge connecting two nodes in the graph 802 based on the area of overlap between the tolerance regions around the respective neuronal elements corresponding to the nodes in the image 810 (e.g., based on a proximity of the respective neuronal elements). The area of overlap can be measured, e.g., as the number of voxels in the image 810 that are contained in the overlap of the respective tolerance regions around the neuronal elements. The weight for an edge connecting two nodes in the graph 802 can be understood as characterizing the (approximate) strength of the biological connection between the corresponding neuronal elements in the brain (e.g., the amount of information flow through the synapse connecting two neurons).

In addition to identifying biological connections in the image 810, the graphing system 812 can further determine the direction of each biological connection using any appropriate technique. The “direction” of a biological connection between two neuronal elements refers to the direction of information flow between the two neuronal elements, e.g., if a first neuron uses a synapse to transmit signals to a second neuron, then the direction of the synapse would point from the first neuron to the second neuron. Example techniques for determining the directions of biological connections connecting pairs of neuronal elements are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system 812 determines the directions of biological connections in the image 810, the graphing system 812 can associate each edge in the graph 802 with the direction of the corresponding biological connection. That is, the graph 802 can be a directed graph. In some other implementations, the graph 802 can be an undirected graph, i.e., where the edges in the graph are not associated with a direction.

The graph 802 can be represented in any of a variety of ways. For example, the graph 802 can be represented as a two-dimensional array of numerical values with a number of rows and columns equal to the number of nodes in the graph. The component of the array at position (i, j) can have value 1 if the graph includes an edge pointing from node i to node j, and value 0 otherwise. In implementations where the graphing system 812 determines a weight value for each edge in the graph 802, the weight values can be similarly represented as a two-dimensional array of numerical values. More specifically, if the graph includes an edge connecting node i to node j, the component of the array at position (i, j) can have a value given by the corresponding edge weight, and otherwise the component of the array at position (i, j) can have value 0.

FIG. 9 is a flow diagram of an example process 900 for generating a brain hybridization neural network architecture from a brain hybridization graph (e.g., the graph 150 in FIG. 1, the graph 440 in FIG. 4, or the graph 640 in FIG. 6). For convenience, the process 900 will be described as being performed by an architecture mapping engine (e.g., the architecture mapping engine 208 in FIG. 2), which is a system of one or more computers located in one or more locations.

The architecture mapping engine can instantiate a respective artificial neuron in the brain hybridization neural network architecture corresponding to each node in the hybridization graph (802). For example, the architecture mapping engine can map each edge connecting a pair of nodes in the hybridization graph to a connection between a corresponding pair of artificial neurons in the neural network architecture.

Next, the architecture mapping engine can instantiate a respective connection in the brain hybridization neural network architecture corresponding to each edge in the hybridization graph (804). For example, the architecture mapping engine can map each edge connecting a pair of nodes in the hybridization graph to a connection between a corresponding pair of artificial neurons in the neural network architecture. The details of the process 800 are described in more detail below.

In one example, the brain hybridization neural network architecture corresponding to the hybridization graph can include: (i) a respective artificial neuron corresponding to each node in the graph, and (ii) a respective connection corresponding to each edge in the graph. In this example, the graph can be a directed graph, and an edge that points from a first node to a second node in the graph can specify a connection pointing from a corresponding first artificial neuron to a corresponding second artificial neuron in the architecture. The connection pointing from the first artificial neuron to the second artificial neuron can indicate that the output of the first artificial neuron should be provided as an input to the second artificial neuron.

Each connection in the architecture can be associated with a weight value, e.g., that is specified by the weight value associated with the corresponding edge in the graph. An artificial neuron can refer to a component of the architecture that is configured to receive one or more inputs (e.g., from one or more other artificial neurons), and to process the inputs to generate an output. The inputs to an artificial neuron and the output generated by the artificial neuron can be represented as scalar numerical values. In one example, a given artificial neuron can generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the hybridization graph can be an undirected graph, and the architecture mapping engine can map an edge that connects a first node to a second node in the graph to two connections between a corresponding first artificial neuron and a corresponding second artificial neuron in the brain hybridization neural network architecture. In particular, the architecture mapping engine can map the edge to: (i) a first connection pointing from the first artificial neuron to the second artificial neuron, and (ii) a second connection pointing from the second artificial neuron to the first artificial neuron.

In another example, the hybridization graph can be an undirected graph, and the architecture mapping engine can map an edge that connects a first node to a second node in the graph to one connection between a corresponding first artificial neuron and a corresponding second artificial neuron in the brain hybridization neural network architecture. The architecture mapping engine can determine the direction of the connection between the first artificial neuron and the second artificial neuron, e.g., by randomly sampling the direction in accordance with a probability distribution over the set of two possible directions.

In some cases, the edges in the graph are not associated with weight values, and the weight values corresponding to the connections in the architecture can be determined randomly. For example, the weight value corresponding to each connection in the architecture can be randomly sampled from a predetermined probability distribution, e.g., a standard Normal (N(0,1)) probability distribution.

In another example, the brain hybridization neural network architecture corresponding to the brain hybridization graph can include: (i) a respective artificial neural network layer corresponding to each node in the graph, and (ii) a respective connection corresponding to each edge in the graph. In this example, a connection pointing from a first layer to a second layer can indicate that the output of the first layer should be provided as an input to the second layer. An artificial neural network layer can refer to a collection of artificial neurons, and the inputs to a layer and the output generated by the layer can be represented as ordered collections of numerical values (e.g., tensors of numerical values). In one example, the architecture can include a respective convolutional neural network layer corresponding to each node in the graph, and each given convolutional layer can generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each edge can be specified by the weight value associated with the corresponding edge in the sub-graph), h_{θ}(⋅) represents the operation of applying one or more convolutional kernels to an input to generate a corresponding output, and σ(⋅) is a non-linear activation function that is applied element-wise to each component of its input. In this example, each convolutional kernel can be represented as an array of numerical values, e.g., where each component of the array is randomly sampled from a predetermined probability distribution, e.g., a standard Normal probability distribution.

In another example, the architecture mapping engine can determine that the brain hybridization neural network architecture corresponding to the brain hybridization graph includes: (i) a respective group of artificial neural network layers corresponding to each node in the graph, and (ii) a respective connection corresponding to each edge in the graph. The layers in a group of artificial neural network layers corresponding to a node in the graph can be connected, e.g., as a linear sequence of layers, or in any other appropriate manner.

The brain hybridization neural network architecture can include one or more artificial neurons that are identified as “input” artificial neurons and one or more artificial neurons that are identified as “output” artificial neurons. An input artificial neuron can refer to an artificial neuron that is configured to receive an input from a source that is external to the neural network. An output artificial neural neuron can refer to an artificial neuron that generates an output which is considered part of the overall output generated by the neural network. The architecture mapping engine can add artificial neurons to the architecture in addition to those specified by nodes in the hybridization graph, and designate the added neurons as input artificial neurons and output artificial neurons.

For example, for a neural network that is configured to process an input including a 100×100 image to generate an output indicating whether the image is included in each of 1000 categories, the architecture mapping engine can add 10,000 (=100×100) input artificial neurons and 1000 output artificial neurons to the brain hybridization neural network architecture. Input and output artificial neurons that are added to the architecture can be connected to the other neurons in the architecture in any of a variety of ways. For example, the input and output artificial neurons can be densely connected to every other neuron in the architecture.

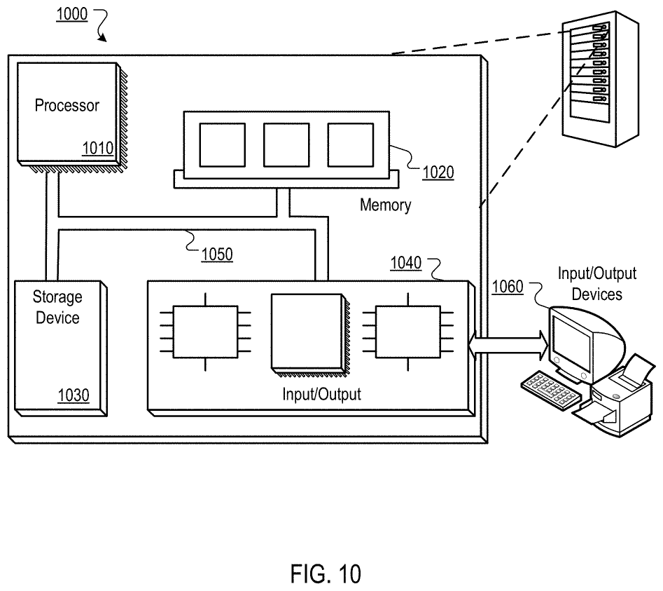

FIG. 10 is a block diagram of an example computer system 1000 that can be used to perform operations described previously. The system 1000 includes a processor 1010, a memory 1020, a storage device 1030, and an input/output device 1040. Each of the components 1010, 1020, 1030, and 1040 can be interconnected, for example, using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 can include, for example, a hard disk device, an optical disk device, a storage device that is shared over a network by multiple computing devices (for example, a cloud storage device), or some other large capacity storage device.

The input/output device 1040 provides input/output operations for the system 1000. In one implementation, the input/output device 1040 can include one or more network interface devices, for example, an Ethernet card, a serial communication device, for example, and RS-232 port, and/or a wireless interface device, for example, and 802.11 card. In another implementation, the input/output device 1040 can include driver devices configured to receive input data and send output data to other input/output devices, for example, keyboard, printer and display devices 1060. Other implementations, however, can also be used, such as mobile computing devices, mobile communication devices, and set-top box television client devices.

Although an example processing system has been described in FIG. 9, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus, the method comprising:
obtaining a network input; and
processing the network input using a neural network to generate a network output that defines a prediction for the network input, comprising:
processing the network input using an encoding sub-network of the neural network to generate an embedding of the network input;
processing the embedding of the network input using a brain hybridization sub-network of the neural network to generate an alternative embedding of the network input, wherein:
the brain hybridization sub-network has a neural network architecture that is specified by a brain hybridization graph; and
the brain hybridization graph is a combination of at least: (i) a first sub-graph of a first synaptic connectivity graph representing synaptic connectivity between a plurality of biological neuronal elements in a first biological organism brain, and (ii) a second sub-graph of a second synaptic connectivity graph representing synaptic connectivity between a plurality of biological neuronal elements in a second biological organism brain; and
processing the alternative embedding of the network input using a decoding sub-network of the neural network to generate the network output that defines the prediction for the network input.

2. The method of claim 1, wherein the first biological organism brain is of a first biological organism and the second biological organism brain is of a second biological organism, and wherein the first biological organism and the second biological organism are different biological organisms.

3. The method of claim 1, wherein each biological neuronal element is a biological neuron, a part of a biological neuron, or a group of biological neurons.

4. The method of claim 1, wherein the first sub-graph of the first synaptic connectivity graph is selected based on a set of features that characterize a biological function of the corresponding biological neuronal elements in the first biological organism brain, and the second sub-graph of the second synaptic connectivity graph is selected based on a set of features that characterize a biological function of the corresponding biological neuronal elements in the second biological organism brain.

5. The method of claim 4, wherein the biological function of the corresponding biological neuronal elements in the first biological organism brain, and the biological function of the corresponding biological neuronal elements in the second biological organism brain, are different biological functions.

6. The method of claim 1, wherein the first sub-graph is represented as a first two-dimensional weight matrix of brain emulation parameters.

7. The method of claim 6, wherein the first weight matrix has a plurality of rows and a plurality of columns,
wherein each row and each column of the first weight matrix corresponds to a respective biological neuronal element in the first biological organism brain, and
wherein each brain emulation parameter in the first weigh matrix corresponds to a respective pair of biological neuronal elements in the first biological organism brain comprising: (i) the biological neuronal element corresponding to a row of the brain emulation parameter in the first weight matrix, and (ii) the biological neuronal element corresponding to a column of the brain emulation parameter in the first weight matrix.

8. The method of claim 6, wherein the second sub-graph is represented as a second two-dimensional weight matrix of brain emulation parameters.

9. The method of claim 8, wherein the second weight matrix has a plurality of rows and a plurality of columns,
wherein each row and each column of the second weight matrix corresponds to a respective biological neuronal element in the second biological organism brain, and
wherein each brain emulation parameter in the second weigh matrix corresponds to a respective pair of biological neuronal elements in the second biological organism brain comprising: (i) the biological neuronal element corresponding to a row of the brain emulation parameter in the second weight matrix, and (ii) the biological neuronal element corresponding to a column of the brain emulation parameter in the second weight matrix.

10. The method of claim 8, wherein the brain hybridization graph is defined by a two-dimensional weight matrix, wherein the weight matrix of the brain hybridization graph is generated by combining at least the first weight matrix representing the first sub-graph and the second weight matrix representing the second sub-graph.

11. The method of claim 10, wherein generating the weight matrix of the brain hybridization graph comprises:
concatenating at least the first weight matrix representing the first sub-graph and the second weight matrix representing the second sub-graph.

12. The method of claim 10, wherein generating the weight matrix of the brain hybridization graph comprises:
determining the weight matrix of the brain hybridization graph as a linear combination of at least the first weight matrix representing the first sub-graph and the second weight matrix representing the second sub-graph.

13. The method of claim 12, wherein determining the linear combination of the first weight matrix representing at least the first sub-graph and the second weight matrix representing the second sub-graph comprises:
determining a mixing factor; and
linearly combining the first weight matrix representing the first sub-graph and the second weight matrix representing the second sub-graph in accordance with the mixing factor.

14. The method of claim 13, wherein determining the mixing factor comprises:
processing the network input, or an intermediate output of the encoding sub-network, using one or more neural network layers to generate the mixing factor.

15. The method of claim 13, wherein the mixing factor is a hyperparameter of the brain hybridization sub-network.

16. The method of claim 1, wherein the brain hybridization graph is determined by operations comprising:
initializing the brain hybridization graph as the first sub-graph of the first synaptic connectivity graph representing synaptic connectivity between the plurality of biological neuronal elements in the first biological organism brain;
updating the brain hybridization graph at each of a plurality of iterations, comprising, at each iteration:
generating a plurality of candidate brain hybridization graphs based on the brain hybridization graph;
determining, for each candidate brain hybridization graph, a respective similarity measure between the candidate brain hybridization graph and the second sub-graph representing synaptic connectivity between biological neuronal elements in the second biological organism brain; and
updating the brain hybridization graph based on the similarity measures determined for candidate brain hybridization graphs; and
determining the brain hybridization graph based on the similarity measures determined for the candidate brain hybridization graphs over the plurality of iterations.

17. The method of claim 16, wherein generating the plurality of candidate brain hybridization graphs based on the brain hybridization graph, comprises, for each candidate brain hybridization graph:
determining the candidate brain hybridization graph by applying a graph modification operator to the brain hybridization graph to add one or more nodes, one or more edges, or both, to the brain hybridization graph.

18. The method of claim 17, wherein determining, for each candidate brain hybridization graph, the respective similarity measure between the candidate brain hybridization graph and the second sub-graph representing synaptic connectivity between the plurality of biological neuronal elements in the second biological organism brain comprises, for each candidate brain hybridization graph:
determining a first set of graph statistics characterizing the candidate brain hybridization graph;
determining a second set of graph statistics characterizing the second sub-graph; and
determining the similarity measure between the candidate brain hybridization graph and the second sub-graph based on a similarity between the first set of graph statistics and the second set of graph statistics.

19. A system comprising:
one or more computers; and
one or more storage devices communicatively coupled to the one or more computers, wherein the one or more storage devices store instructions that, when executed by the one or more computers, cause the one or more computers to perform operations comprising:
obtaining a network input;
processing the network input using a neural network to generate a network output that defines a prediction for the network input, comprising:
processing the network input using an encoding sub-network of the neural network to generate an embedding of the network input;
processing the embedding of the network input using a brain hybridization sub-network of the neural network to generate an alternative embedding of the network input, wherein:
the brain hybridization sub-network has a neural network architecture that is specified by a brain hybridization graph; and
the brain hybridization graph is a combination of at least: (i) a first sub-graph of a first synaptic connectivity graph representing synaptic connectivity between a plurality of biological neuronal elements in a first biological organism brain, and (ii) a second sub-graph of a second synaptic connectivity graph representing synaptic connectivity between a plurality of biological neuronal elements in a second biological organism brain; and
processing the alternative embedding of the network input using a decoding sub-network of the neural network to generate the network output that defines the prediction for the network input.

20. One or more non-transitory computer storage media storing instructions that when executed by one or more computers cause the one or more computers to perform operations comprising:
obtaining a network input;
processing the network input using a neural network to generate a network output that defines a prediction for the network input, comprising:
processing the network input using an encoding sub-network of the neural network to generate an embedding of the network input;
processing the embedding of the network input using a brain hybridization sub-network of the neural network to generate an alternative embedding of the network input, wherein:
the brain hybridization sub-network has a neural network architecture that is specified by a brain hybridization graph; and
the brain hybridization graph is a combination of at least: (i) a first sub-graph of a first synaptic connectivity graph representing synaptic connectivity between a plurality of biological neuronal elements in a first biological organism brain, and (ii) a second sub-graph of a second synaptic connectivity graph representing synaptic connectivity between a plurality of biological neuronal elements in a second biological organism brain; and
processing the alternative embedding of the network input using a decoding sub-network of the neural network to generate the network output that defines the prediction for the network input.
